(19) United States
(12) Patent Application Publication
(10) Pub. No.: US 2010/0284306 A1
(43) Pub. Date: Nov. 11, 2010

(54) BINDING UPDATING METHOD AND MOBILE TERMINAL USED BY THE METHOD

(75) Inventor: Tetsuro Morimoto, Kanagawa (JP)

Correspondence Address: PEARNE & GORDON LLP, 1801 EAST 9TH STREET, SUITE 1200, CLEVELAND, OH, 44114-3108, US

(73) Assignee: PANASONIC CORPORATION, Osaka (JP)

(21) Appl. No.: 12/811,864

(22) PCT Filed: Dec. 25, 2008
(86) PCT No.: PCT/JP2008/003984

§ 371 Date: Jul. 7, 2010

(30) Foreign Application Priority Data
Jan. 9, 2008 (JP) 2008-002555

(51) Int. Cl. H04L 12/28

(52) U.S. Cl. 370/254

(57) ABSTRACT

Disclosed is a technique for providing a binding updating method and the like, capable of reducing the number of messages, and hence the power consumption of terminals and processing time required for binding update between terminals. According to the technique, the method includes the following steps: A predetermined mobile terminal sends a mobile terminal as the next destination first and second messages including predetermined information for each of other mobile terminals based on a predetermined order of message transmission. A mobile terminal that has received the first and second messages acquires predetermined information addressed to its own terminal, adds predetermined information for each of mobile terminals other than its own terminal to the first and second messages, and sends the first and second messages to a mobile terminal as the next destination based on the predetermined order of message transmission. A mobile terminal that has acquired all pieces of predetermined information addressed to its own terminal generates authentication information for each of the other mobile terminals based on the predetermined information, and creates and sends a third message including the authentication information for each of the other mobile terminals. A terminal that has received the third message updates binding information when the authentication information included in the third message is valid.

### TECHNICAL FIELD

The present invention relates to a binding updating method for updating binding between communication terminals with a path optimized by binding update, and a mobile terminal used by the method.

### BACKGROUND ART

Conventionally, there has been a mobile IP as a technique in which even if a communication device has moved, it can continue to use the same IP address before moving. In the mobile IP, a home agent receives a packet destined to the home address of a mobile node, and forwards it to a care-of address (CoA) of the mobile node. This enables the mobile node to continue communication using the home address regardless of the address change made as a result of moving.

Further, in order to remedy the problem that a communication path between the mobile node and a correspondent node (CN) goes a long way because the packet is routed through the home agent, there is a route optimization technique for directly connecting the mobile node and the correspondent node through a communication path. This route optimization technique features that information of mapping the home address and the care-of address of the mobile node is stored at the correspondent node so that communication will be performed using the care-of address. Processing for storing the information of mapping the home address and the care-of address of the mobile node at this correspondent node is called binding update (BU) processing.

The binding update processing for the correspondent node differs from binding update processing for the home agent in that it requires binding update preprocessing (RR: Return Routability Procedure). Since a confidential relationship can be established between the home agent and the mobile node in advance, this binding update preprocessing is not required. In the binding update processing for the home agent, when the mobile node notifies the home agent of a new care-of address for the home address, the home agent can confirm that the notification is a binding update request from the mobile node based on the confidential relationship (IPsec SA or the like) established beforehand.

On the other hand, it is difficult for the correspondent node to establish confidential relationships between mobile node and correspondent node for all possible communication devices as communication partners before performing binding update processing. If the correspondent node complies with a binding update request without any confidential relationship, it makes it easy for an attacker to pretend to be a mobile node. In this case, if the attacker performs binding update processing for the correspondent node, it allows a packet for the mobile node to be forwarded to an unauthorized care-of address. A technique for preventing this is binding update preprocessing.

Specifically, in the binding update preprocessing, home address test processing (Home Test) and care-of address test processing (Care-of Test) are performed. These processing results are reflected in the binding update processing to prevent unauthorized binding update processing. The mobile IP, route optimization and binding update preprocessing as conventional techniques are described in Non-Patent Document 1 cited below. The design concept of the binding update preprocessing is described in Non-Patent Document 2 cited below.

The binding update preprocessing will be described in a little more detail. In the home address test processing, the mobile node sends the correspondent node a HoTI (Home Test Init) message, and the correspondent node returns a Home Test (HoT) message. In the care-of address test processing, the mobile node sends the correspondent node a Care-of Test Init (CoTI) message, and the correspondent node returns a Care-of Test (CoT) message.

The mobile node generates a key based on a Home Keygen token (Home token) and a Care-of keygen token (Care-of token) included in the HoT message and the CoT message returned from the correspondent node, calculates a message authentication code (MAC) of a binding update (BU) message using the key, and sends a BU message with the MAC added thereto.

The correspondent node that has received the BU message checks the message authentication code and determines that it is a valid BU message from the mobile node. According to Non-Patent Document 2 in which the design concept of the binding update preprocessing is described, this binding update preprocessing is so designed that the correspondent node will not have to have State. In other words, the correspondent node can perform authentication processing on the BU message without storing information as to whether it has ever received a HoTI message and a CoTI message.

This is to minimize the damage to the correspondent node when an attacker uses a HoTI message or CoTI message to make a Denial of Service (DoS) attack against the correspondent node. Further, a HoT message is returned in response to a HoTI message, and a CoT message is returned in response to a CoTI message. Thus, one response message is returned in response to one request message. This is to prevent the amplification of messages. If two or more response messages are returned in response to one request message, the attacker can attack two or more targets by sending one message.

Non-Patent Document 1: “Mobility Support in IPv6,” RFC3775

Non-Patent Document 2: “Mobile IP Version 6 Route Optimization Security Design Background,” RFC4225

However, MIPv6 in the aforementioned conventional techniques requires mobile terminals to perform binding update independently even when many mobile terminals are performing binding update to one another. This causes a problem of the waste of batteries because each mobile terminal has to send and receive many messages periodically (every seven minutes). In other words, as shown in FIGS. 19A to 19C, since mobile terminals perform binding update to one another periodically, they have to send and receive many messages, resulting in the waste of batteries.

### DISCLOSURE OF THE INVENTION

In view of the above-mentioned problems, it is an object of the present invention to provide a binding updating method and a mobile terminal used by the method, capable of reducing the number of messages required for binding update between terminals, reducing the power consumption of terminals due to the reduction in the number of messages, and further reducing the processing time required for binding update between terminals.

In order to attain the above object, according to the present invention, there is provided a binding updating method for updating binding information for enabling route optimization between two mobile terminals of multiple mobile terminals in a communication network using the multiple mobile terminals, the method comprising the steps of: causing a predetermined mobile terminal of the multiple mobile terminals to send a mobile terminal as the next destination a first message and a second message including predetermined information for each of other mobile terminals based on a predetermined order of message transmission; causing a mobile terminal that has received the first and second messages to acquire predetermined information included in the first and second messages and addressed to its own terminal, add predetermined information for each of the mobile terminals other than its own terminal to the first and second messages, and send the first and second messages to a mobile terminal as the next destination based on the predetermined order of message transmission; causing a mobile terminal that has acquired all pieces of predetermined information addressed to its own terminal to generate authentication information for each of other mobile terminals based on the acquired predetermined information, and create and send a third message including the generated authentication information for each of the other mobile terminals; and causing a mobile terminal that has received the third message to update the binding information when the authentication information included in the third message is validated. This configuration can reduce the number of messages required for binding update between terminals, and due to the reduction in the number of messages, the power consumption of terminals can be reduced, and the processing time required for binding update between terminals can also be reduced. Note that “to be valid” means that message authentication codes match as a result of comparison to be described later.

According to a preferred form of the present invention, in the binding updating method of the present invention, the predetermined order of message transmission is such that the order of transmission of the first message is different from the order of transmission of the second message. This configuration can prevent all pieces of Token information addressed to a mobile terminal from being gathered by other mobile terminals.

According to another form of the present invention, the binding updating method of the present invention is such that the predetermined mobile terminal generates, for each of the mobile terminals, authentication information for the forwarding determination of message based on predetermined information on the mobile terminals other than the predetermined mobile terminal, adds the generated authentication information for the forwarding determination to the first and second messages, and sends the first and second messages. This configuration enables secure forwarding determination.

According to still another form of the present invention, the binding updating method of the present invention is such that the mobile terminal that has received the first and second messages adds, to the first and second messages, predetermined information used upon transmission of the first and second messages for the next binding update. This configuration eliminates the need to collect information each time binding update is performed, enabling reduction in the number of messages.

According to the present invention, there is also provided a mobile terminal used by a binding updating method for updating binding information for enabling route optimization between two mobile terminals of multiple mobile terminals in a communication network using the multiple mobile terminals, the mobile terminal comprising: message creation means for creating a first message and a second message including predetermined information for each of other mobile terminals; transmitting means for sending the created first and second messages to a mobile terminal as the next destination based on a predetermined order of message transmission; receiving means for receiving the first and second messages passed around among the multiple mobile terminals; acquisition means for acquiring predetermined information added to the received first and second messages and addressed to its own terminal; authentication information generating means for generating authentication information for each of the mobile terminals other than its own terminal based on the predetermined information acquired; determination means for determining whether the received authentication information is valid when the messages including the authentication information sent from mobile terminals other than its own terminal have been received through the receiving means; and updating means for updating the binding information when the authentication information is determined to be valid, wherein the messages including the authentication information generated by the message generation means are sent to the mobile terminals other than its own terminal through the transmitting means. This configuration can reduce the number of messages required for binding update between terminals, and due to the reduction in the number of messages, the power consumption of terminals can be reduced, and the processing time required for binding update between terminals can also be reduced.

According to a preferred form of the present invention, in the mobile terminal of the present invention, the predetermined order of message transmission is such that the order of transmission of the first message is different from the order of transmission of the second message. This configuration can prevent all pieces of Token information addressed to a mobile terminal from being gathered by other mobile terminals.

According to another form of the present invention, the mobile terminal of the present invention is such that the authentication information generating means generates, for each of the mobile terminals, authentication information for the forwarding determination of message based on predetermined information on the mobile terminals other than its own terminal, and adds the generated authentication information for the forwarding determination to the first and second messages, and the transmitting means sends the first and second messages to which the authentication information for the forwarding determination is added. This configuration enables secure forwarding determination.

Further, according to the present invention, there is provided a mobile terminal used by a binding updating method for updating binding information for enabling route optimization between two mobile terminals of multiple mobile terminals in a communication network using the multiple mobile terminals, the mobile terminal comprising: receiving means for receiving a first message and a second message as messages sent from a predetermined mobile terminal of the multiple mobile terminals and including predetermined information for each of mobile terminals other than the predetermined mobile terminal; acquisition means for acquiring predetermined information included in the received first and second messages and addressed to its own terminal; addition means for adding, to the first and second messages, predetermined information for each of mobile terminals other than its own terminal; transmitting means for sending other mobile terminals the first and second messages to which the predetermined information is added; authentication information generating means for generating authentication information for each of other mobile terminals based on the acquired predetermined information when all pieces of predetermined information addressed to its own terminal are acquired; message creation means for creating a message including the generated authentication information for each of the other mobile terminals; determination means for determining whether the received authentication information is valid when the message including the authentication information sent from mobile terminals other than its own terminal have been received through the receiving means; and updating means for updating the binding information when the authentication information is determined to be valid, wherein the message created by the message creation means is sent to each of the other mobile terminals. This configuration can reduce the number of messages required for binding update between terminals, and due to the reduction in the number of messages, the power consumption of terminals can be reduced, and the processing time required for binding update between terminals can also be reduced.

According to a preferred form of the present invention, the mobile terminal of the present invention is such that when receiving the first and second messages through the receiving means, the addition means adds, to the first and second messages, predetermined information used upon transmission of the first and second messages for the next binding update. This configuration eliminates the need to collect information each time binding update is performed, enabling reduction in the number of messages.

According to the present invention, the binding updating method and the mobile terminal used by the method have the aforementioned configurations, so that the number of messages required for binding update between terminals can be reduced, and due to the reduction in the number of messages, not only the power consumption of terminals but also the processing time required for binding update between terminals can be reduced.

### BRIEF DESCRIPTION OF THE DRAWINGS

FIG. 1A It is a diagram showing a case where three terminals A, B and C perform BU, respectively, according to a first embodiment of the present invention.

FIG. 1B It is a diagram showing a case where messages in FIG. 1A are divided.

FIG. 1C It is a diagram showing a case where the divided messages in FIG. 1B are sorted.

FIG. 1D It is a diagram showing a case where the messages in FIG. 1C are put together.

FIG. 2 It is a block diagram showing an example of the configuration of a mobile terminal on the side of initiating ring binding update according to first to third embodiments of the present invention.

FIG. 3 It is a block diagram showing an example of the configuration of a mobile terminal on the side of participating in ring binding update according to the first to third embodiments of the present invention.

FIG. 4 It is a flowchart for describing an example of a processing flow in a mobile terminal on the side of initiating ring binding update according to the first and second embodiments of the present invention.

FIG. 5 It is a flowchart for describing an example of a processing flow in a mobile terminal on the side of participating in ring binding update according to the first and second embodiments of the present invention.

FIG. 6A It is a diagram showing a case were three terminals A, B and C perform BU, respectively, according to the second embodiment of the present invention.

FIG. 6B It is a diagram showing a case where messages in FIG. 6A are divided.

FIG. 6C It is a diagram showing a case where the divided messages in FIG. 6B are sorted.

FIG. 6D It is a diagram showing a case where the messages in FIG. 6C are put together.

FIG. 7A It is a diagram representing one flow of messages shown in FIG. 6D.

FIG. 7B It is a diagram representing another flow of messages shown in FIG. 6D.

FIG. 7C It is a diagram representing still another flow of messages shown in FIG. 6D.

FIG. 8 It is a diagram for comparing the number of messages in the second embodiment of the present invention.

FIG. 9A It is an illustration for describing a way of generating an authentication code for forwarding determination according to the third embodiment of the present invention.

FIG. 9B It is an illustration for describing the way of generating the authentication code for forwarding determination according to the third embodiment of the present invention.

FIG. 10A It is an illustration for describing another way of generating an authentication code for forwarding determination according to the third embodiment of the present invention.

FIG. 10B It is an illustration for describing the other way of generating the authentication code for forwarding determination according to the third embodiment of the present invention.

FIG. 11A It is an illustration for describing forwarding determination processing for a HoT ring message at terminal C according to the third embodiment of the present invention.

FIG. 11B It is another illustration for describing the forwarding determination processing for the HoT ring message at terminal C according to the third embodiment of the present invention.

FIG. 11C It is still another illustration for describing the forwarding determination processing for the HoT ring message at terminal C according to the third embodiment of the present invention.

FIG. 12A It is an illustration for describing forwarding determination processing for a CoT ring message at terminal B according to the third embodiment of the present invention.

FIG. 12B It is another illustration for describing the forwarding determination processing for the CoT ring message at terminal B according to the third embodiment of the present invention.

FIG. 12C It is still another illustration for describing the forwarding determination processing for the CoT ring message at terminal B according to the third embodiment of the present invention.

FIG. 13 It is a flowchart for describing an example of a processing flow in a mobile terminal on the side of initiating ring binding update according to the third embodiment of the present invention.

FIG. 14 It is a flowchart for describing an example of a processing flow in a mobile terminal on the side of participating in ring binding update according to the third embodiment of the present invention.

FIG. 15 It is a block diagram showing an example of the configuration of a mobile terminal on the side of initiating ring binding update according to a fourth embodiment of the present invention.

FIG. 16 It is a block diagram showing an example of the configuration of a mobile terminal on the side of participating in ring binding update according to the fourth embodiment of the present invention.

FIG. 17 It is a flowchart for describing an example of a processing flow in a mobile terminal on the side of initiating ring binding update according to the fourth embodiment of the present invention.

FIG. 18 It is a flowchart for describing an example of a processing flow in a mobile terminal on the side of participating in ring binding update according to the fourth embodiment of the present invention.

FIG. 19A It is a diagram for describing a problem in conventional binding update.

FIG. 19B It is a diagram for describing the problem in conventional binding update.

FIG. 19C It is a diagram for describing the problem in conventional binding update.

### BEST MODE FOR CARRYING OUT THE INVENTION

### First Embodiment

A first embodiment will now be described. Here, it is configured such that HoT and CoT, which are sent directly to a communication partner in the conventional, are once relayed to another terminal, and sent to a destination terminal from the relay terminal. Note that the number of terminals is three in the description of this embodiment, but it is not limited to three.

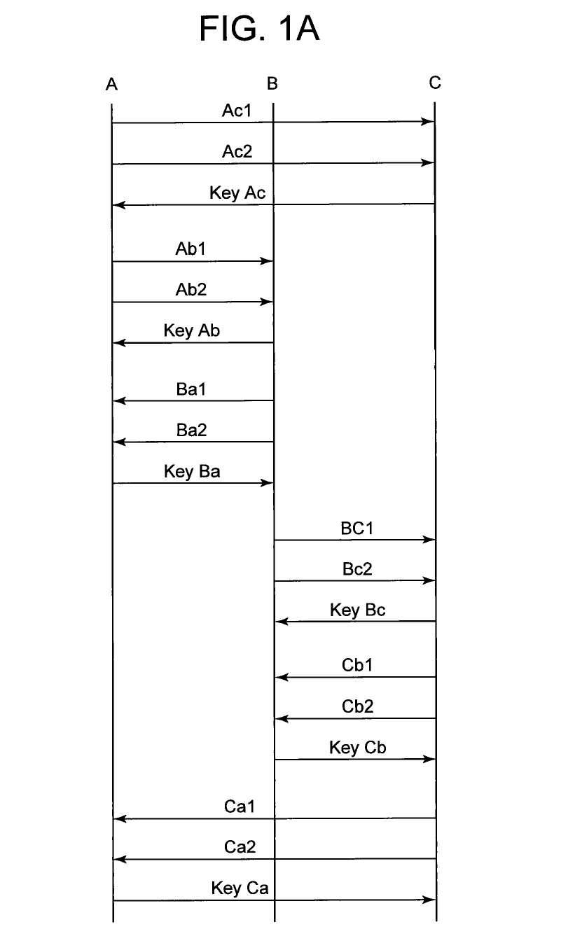

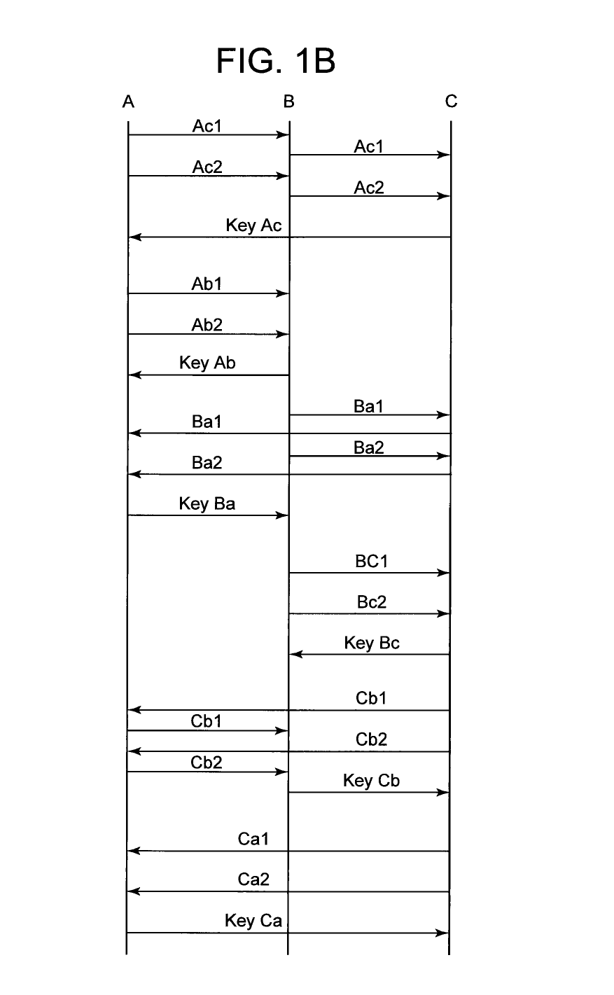

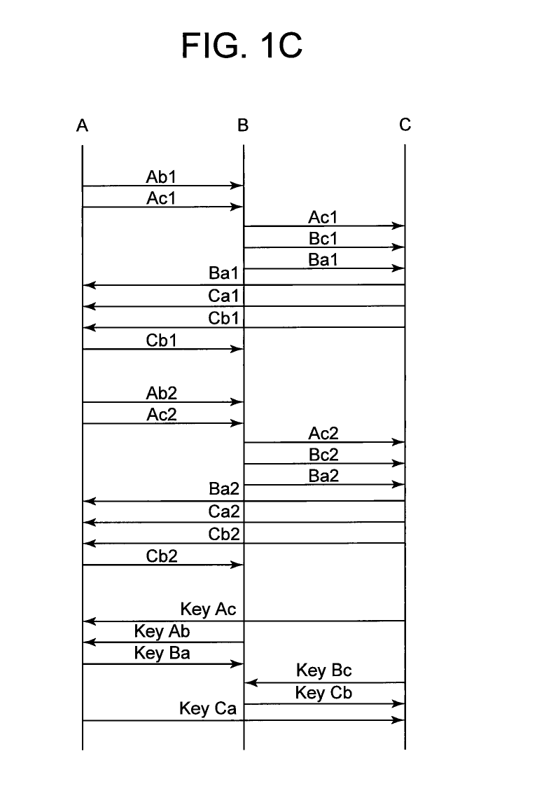

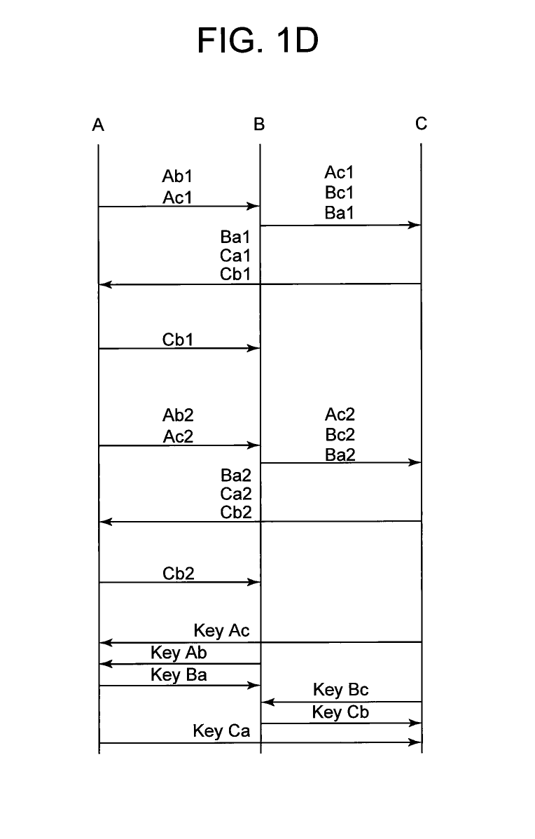

Upon forwarding, the relay terminal also sends a HoT message (which may be simply referred to as HoT below) and a CoT message (which may be simply referred to as CoT below) to be sent from the relay terminal itself. This can reduce the number of messages as shown in FIG. 1D (indicating HoT in an upper part, CoT in a middle part, and BU in a lower part). FIG. 1A is a diagram showing a case where three terminals A, B, and C perform BU, respectively, FIG. 1B is a diagram showing a case where messages in FIG. 1A are divided, and FIG. 1C is a diagram showing a case where the divided messages in FIG. 1B are sorted.

HoT sent from the terminal A includes information Ab1 and Ac1, and the HoT is delivered to the terminal B. In this case, the terminal B takes information Ab1, newly adds information Bc1 and Ba1 to the HoT, and sends the HoT to the terminal C. When receiving the HoT, the terminal C picks up information Ac1 and Bc1 from the HoT, newly adds information Ca1 and Cb1 to the HoT, and sends the HoT to the terminal A. When receiving the HoT, the terminal A picks up the information Ba1 and Ca1 from the HoT and forwards them to the terminal B. The terminal B takes the information Cb1. Thus, the number of messages can be reduced to four, whereas six HoTs are necessary in the conventional.

Similarly, CoT sent from the terminal A includes information Ab2 and Ac2, and the CoT is delivered to the terminal B. In this case, the terminal B takes information Ab2, newly adds information Bc2 and Ba2 to the CoT, and sends the CoT to the terminal C. When receiving the CoT, the terminal C picks up information Ac2 and Bc2 from the CoT, newly adds information Ca2 and Cb2 to the CoT, and sends the CoT to the terminal A. When receiving the CoT coming around, the terminal A picks up information Ba2 and Ca2 from the CoT, and forwards the CoT to the terminal B. The terminal B picks up information Cb2 from the CoT. As a result of receiving the HoT and the CoT, each terminal generates key data from a gathered set of home token and care-of token, enabling transmission of BU. A message sent from a terminal (here, terminal A) and forwarded along relayed paths through which necessary HoTI/HoT processing is performed sequentially via other terminals (here, terminal B and terminal C) is called a HoT ring or HoT ring message below. Further, a message sent from a terminal (here, terminal A) and forwarded along relayed paths through which necessary CoTI/CoT processing is performed sequentially via other terminals (here, terminal B and terminal C) is called a CoT ring or CoT ring message.

The above method can reduce the number of HoT messages and CoT messages. The HoT message and the CoT message are not combined into one message. This is because the HoT message is a message to confirm reaching the HoA of each terminal and the CoT message is a message to confirm reaching the CoA of each terminal.

The following describes the first embodiment in more detail, i.e., about a case where the HoT ring message and the CoT ring message are passed around in the same direction. First, a description will be given of the initiation of HoT ring and CoT ring at the terminal A. Here, there are the terminal A, the terminal B and the terminal C. The terminal A performs binding update to the terminal B, and the terminal B performs binding update to the terminal A as well. Similarly, the terminal A performs binding update to the terminal C, and the terminal C performs binding update to the terminal A as well.

In this situation, the terminal A has to perform binding update to the terminal B and the terminal C every seven minutes in order to use the care-of address (CoA) continuously. Therefore, in order to reduce the total number of messages sent and received among the three terminals, the terminal A starts binding update processing (also called inter-group binding update processing or ring binding update processing) according to the present invention. The terminal A decides to send a HoT ring message passed around in a direction from the terminal B to the terminal C (terminal A→terminal B→terminal C) and a CoT ring message passed around in the same direction, and generates ring data as shown below. This ring data is added to each ring message, enabling a receiving terminal to know a terminal to which the ring data is to be sent next. The receiving terminal can also decide on Tokens to be added to the ring message.

HoT Ring Data=(B-Home Address, C-Home Address, A-Home Address)

CoT Ring Data=(B-Care-of Address, C-Care-of Address, A-Care-of Address)

Further, the terminal A generates Tokens to be sent to the terminal B and the terminal C. It is assumed that these Tokens are called HoT Ring Token and CoT Ring Token. Note that a token generation algorithm (Here, SHA1) and information necessary for the generation may be different algorithm and different information.

AB-HoT Ring Token=SHA1 (B-Home Address, A's secret key, AB-HoT ring nonce)

AC-HoT Ring Token=SHA1 (C-Home Address, A's secret key, AC-HoT ring nonce)

AB-CoT Ring Token=SHA1 (B-Care-of Address, A's secret key, AB-CoT ring nonce)

AC-CoT Ring Token=SHA1 (C-Care-of Address, A's secret key, AC-CoT ring nonce)

Using these pieces of information, the terminal A creates the HoT ring message and the CoT ring message. The following information is added to the HoT ring message, i.e., B-Home Address, AB-HoT Ring Token, AB-HoT ring nonce, C-Home Address, AC-HoT Ring Token, AC-HoT ring nonce and HoT Ring Data are added. Similarly, the following information is added to the CoT ring message, i.e., B-Care-of Address, AB-CoT Ring Token, AB-CoT ring nonce, C-Care-of Address, AC-CoT Ring Token, AC-CoT ring nonce and CoT Ring Data are added. The terminal A sends the HoT ring message to the home address of the terminal B, and the CoT ring message to the care-of address of the terminal B.

Next, HoT ring processing at the terminal B will be described. When receiving the HoT ring message, the terminal B extracts and holds Ring Tokens addressed to the terminal B. In other words, the terminal B extracts and holds B-Home Address, AB-HoT Ring Token and AB-HoT ring nonce, and deletes them from the HoT ring message. Before starting the HoT ring processing, the terminal B may check the presence of a binding cache between the terminal B and the terminal A. Then, the terminal B generates HoT Ring Tokens, i.e., the following information:

BC-HoT Ring Token=SHA1 (C-Home Address, B's secret key, BC-HoT ring nonce)

BA-HoT Ring Token=SHA1 (A-Home Address, B's secret key, BA-HoT ring nonce)

Then, the terminal B adds, to the HoT ring message, the following information for the terminal C and the terminal A:

C-Home Address, BC-HoT Ring Token, BC-HoT ring nonce

A-Home Address, BA-HoT Ring Token, BA-HoT ring nonce

Information included in the HoT ring message to be sent from the terminal B to the terminal C in the above processing is the following information:

C-Home Address, AC-HoT Ring Token, AC-HoT ring nonce (information from the terminal A)

C-Home Address, BC-HoT Ring Token, BC-HoT ring nonce (added by the terminal B)

A-Home Address, BA-HoT Ring Token, BA-HoT ring nonce (added by the terminal B)

HoT Ring Data

Next, HoT ring processing at the terminal C will be described. When receiving the HoT ring message, the terminal C extracts and holds Ring Tokens addressed to the terminal C. In other words, the terminal C holds the following information and deletes it from the HoT ring message:

C-Home Address, AC-HoT Ring Token, AC-HoT ring nonce

C-Home Address, BC-HoT Ring Token, BC-HoT ring nonce

The terminal C generates HoT Ring Tokens for the terminal A and the terminal B, i.e., the following information:

CA-HoT Ring Token=SHA1 (A-Home Address, C's secret key, CA-HoT ring nonce)

CB-HoT Ring Token=SHA1 (B-Home Address, C's secret key, CB-HoT ring nonce)

Then, the terminal C adds, to the HoT ring message, the following information for the terminal A and the terminal B:

A-Home Address, CA-HoT Ring Token, CA-HoT ring nonce

B-Home Address, CB-HoT Ring Token, CB-HoT ring nonce

Information included in the HoT ring message to be sent from the terminal C to the terminal A is the following information:

A-Home Address, BA-HoT Ring Token, BA-HoT ring nonce (information from the terminal B)

A-Home Address, CA-HoT Ring Token, CA-HoT ring nonce (added by the terminal C)

B-Home Address, CB-HoT Ring Token, CB-HoT ring nonce (added by the terminal C)

HoT Ring Data

Next, HoT ring processing at the terminal A will be described. When receiving the HoT ring message, the terminal A extracts and holds Ring Tokens addressed to the terminal A. In other words, the terminal A holds the following information and deletes it from the HoT ring message:

A-Home Address, BA-HoT Ring Token, BA-HoT ring nonce

A-Home Address, CA-HoT Ring Token, CA-HoT ring nonce

Information included in the HoT ring message to be sent from the terminal A to the terminal B in the above processing is the following information:

B-Home Address, CB-HoT Ring Token, CB-HoT ring nonce (added by the terminal C)

HoT Ring Data

Finally, HoT ring processing at the terminal B will be described. When receiving the HoT ring message, the terminal B extracts and holds Ring Tokens addressed to the terminal B. In other words, the terminal B holds the following information, and deletes it from the HoT ring message:

B-Home Address, AB-HoT Ring Token, AB-HoT ring nonce

B-Home Address, CB-HoT Ring Token, CB-HoT ring nonce

Here, since the terminal B is the last receiver, the terminal B does not forward the HoT ring message to the terminal C.

Next, CoT ring processing at the terminal B will be described. The HoT ring processing is almost the same processing as well. When receiving a CoT ring message, the terminal B holds Ring Tokens addressed to the terminal B, i.e., B-Care-of Address, AB-CoT Ring Token and AB-CoT ring nonce. Then, the terminal B generates CoT Ring Tokens, i.e., the following information:

BC-CoT Ring Token=SHA1 (C-Care-of Address, B's secret key, BC-CoT ring nonce)

BA-CoT Ring Token=SHA1 (A-Care-of Address, B's secret key, BA-CoT ring nonce)

Then, the terminal B adds, to the CoT ring message, the following information:

C-Care-of Address, BC-CoT Ring Token, BC-CoT ring nonce

A-Care-of Address, BA-CoT Ring Token, BA-CoT ring nonce

Information included in the CoT ring message to be sent from the terminal B to the terminal C in the above processing is the following information:

C-Care-of Address, AC-CoT Ring Token, AC-CoT ring nonce (information from the terminal A)

C-Care-of Address, BC-CoT Ring Token, BC-CoT ring nonce (added by the terminal B)

A-Care-of Address, BA-CoT Ring Token, BA-CoT ring nonce (added by the terminal B)

CoT Ring Data

Next, CoT ring processing at the terminal C will be described. When receiving the CoT ring message, the terminal C holds Ring Tokens addressed to the terminal C. In other words, the terminal C holds the following information and deletes it from the CoT ring message:

C-Care-of Address, AC-CoT Ring Token, AC-CoT ring nonce

C-Care-of Address, BC-CoT Ring Token, BC-CoT ring nonce

Then, the terminal C generates CoT Ring Tokens, i.e., the following information:

CA-CoT Ring Token=SHA1 (A-Care-of Address, C's secret key, CA-CoT ring nonce)

CB-CoT Ring Token=SHA1 (B-Care-of Address, C's secret key, CB-CoT ring nonce)

Then, the terminal C adds, to the CoT ring message, the following information:

A-Care-of Address, CA-CoT Ring Token, CA-CoT ring nonce

B-Care-of Address, CB-CoT Ring Token, CB-CoT ring nonce

Information included in the CoT ring message to be sent from the terminal C to the terminal A in the above processing is the following information:

A-Care-of Address, BA-CoT Ring Token, BA-CoT ring nonce (information from the terminal B)

A-Care-of Address, CA-CoT Ring Token, CA-CoT ring nonce (added by the terminal C)

B-Care-of Address, CB-CoT Ring Token, CB-CoT ring nonce (added by the terminal C)

CoT Ring Data

Next, CoT ring processing at the terminal A will be described. When receiving the CoT ring message, the terminal A holds Ring Tokens addressed to the terminal A. In other words, the terminal A holds the following information and deletes it from the CoT ring message:

A-Care-of Address, BA-CoT Ring Token, BA-CoT ring nonce

A-Care-of Address, CA-CoT Ring Token, CA-CoT ring nonce

Information included in the CoT ring message to be sent from the terminal A to the terminal B in the above processing is the following information:

B-Care-of Address, CB-CoT Ring Token, CB-CoT ring nonce (information from the terminal C)

CoT Ring Data

Finally, CoT ring processing at the terminal B will be described. When receiving the CoT ring message, the terminal B extracts and holds Ring Tokens addressed to the terminal B. In other words, the terminal B holds the following information and deletes it from the CoT ring message:

B-Care-of Address, AB-CoT Ring Token, AB-CoT ring nonce

B-Care-of Address, CB-CoT Ring Token, CB-CoT ring nonce

Here, since the terminal B is the last receiver, the terminal B does not forward the CoT ring message to the terminal C.

Next, the operation of terminals when receiving both the HoT ring message and the CoT ring message will be described. The terminal B acquires the following information from the HoT ring message:

B-Home Address, AB-HoT Ring Token, AB-HoT ring nonce

B-Home Address, CB-HoT Ring Token, CB-HoT ring nonce

The terminal B also acquires the following information from the CoT ring message:

B-Care-of Address, AB-CoT Ring Token, AB-CoT ring nonce

B-Care-of Address, CB-CoT Ring Token, CB-CoT ring nonce

Using these Tokens, the terminal B generates Keys as key data.

AB-Key=SHA1 (AB-HoT Ring Token, AB-CoT Ring Token)

CB-Key=SHA1 (CB-HoT Ring Token, CB-CoT Ring Token)

Then, using these Keys, the terminal B generates MAC as an authentication code.

AB-MAC=SHA1 (AB-Key, BU-Message Data)

CB-MAC=SHA1 (CB-Key, BU-Message Data)

The terminal B sends the terminal A a BU message to which AB-HoT ring nonce and AB-CoT ring nonce are added together with the generated authentication code and the like. The terminal B also sends the terminal C a BU message to which CB-HoT ring nonce and CB-CoT ring nonce are added together with the generated authentication code and the like.

On the other hand, the terminal C acquires the following information from the HoT ring message:

C-Home Address, AC-HoT Ring Token, AC-HoT ring nonce

C-Home Address, BC-HoT Ring Token, BC-HoT ring nonce

The terminal C also acquires the following information from the CoT ring message:

C-Care-of Address, AC-CoT Ring Token, AC-CoT ring nonce

C-Care-of Address, BC-CoT Ring Token, BC-CoT ring nonce

Using these Tokens, the terminal C generates Keys as key data.

AC-Key=SHA1 (AC-HoT Ring Token, AC-CoT Ring Token)

BC-Key=SHA1 (BC-HoT Ring Token, BC-CoT Ring Token)

Then, using these Keys, the terminal C generates MAC as an authentication code.

AC-MAC=SHA1 (AC-Key, BU Message Data)

BC-MAC=SHA1 (BC-Key, BU Message Data)

The terminal C sends the terminal A a BU message to which AC-HoT ring nonce and AC-CoT ring nonce are added together with the generated authentication code and the like. The terminal C also sends the terminal B a BU message to which BC-HoT ring nonce and BC-CoT ring nonce are added together with the generated authentication code and the like.

On the other hand, the terminal A acquires the following information from the HoT ring message:

A-Home Address, BA-HoT Ring Token, BA-HoT ring nonce

A-Home Address, CA-HoT Ring Token, CA-HoT ring nonce

The terminal A also acquires the following information from the CoT ring message:

A-Care-of Address, CA-CoT Ring Token, CA-CoT ring nonce

A-Care-of Address, BA-CoT Ring Token, BA-CoT ring nonce

Using these Tokens, the terminal A generates Keys as key data.

BA-Key=SHA1 (BA-HoT Ring Token, BA-CoT Ring Token)

CA-Key=SHA1 (CA-HoT Ring Token, CA-CoT Ring Token)

Then, using these Keys, the terminal A generates MAC as an authentication code.

BA-MAC=SHA1 (BA-Key, BU Message Data)

CA-MAC=SHA1 (CA-Key, BU Message Data)

The terminal A sends the terminal B a BU message to which BA-HoT ring nonce and BA-CoT ring nonce are added together with the generated authentication code and the like. The terminal A also sends the terminal C a BU message to which CA-HoT ring nonce and CA-CoT ring nonce are added together with the generated authentication code and the like. The same processing can be performed even in a case where the number of the terminals is four or more. For example, when the number of the terminals is four, the terminal A adds Ring Tokens and sends the HoT ring message and the CoT ring message in such a manner that they will be delivered to terminal B, terminal C and terminal D in this order.

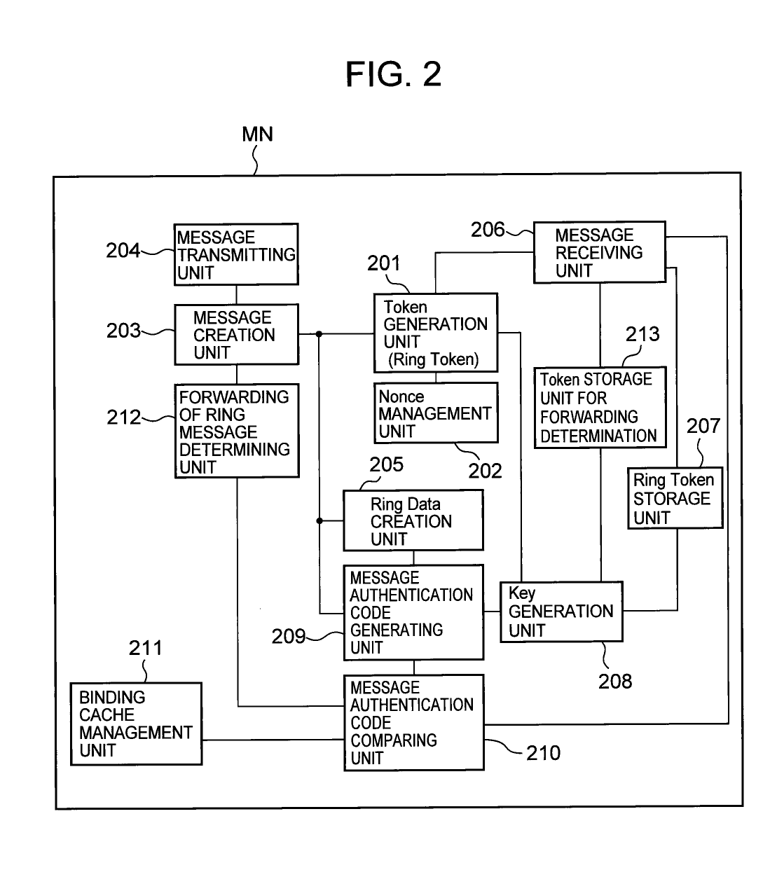

Referring next to FIG. 2, a mobile terminal on the side of initiating the above-mentioned ring binding update will be described. Here, the terminal A is taken as an example in which the terminal A performs ring binding update to the terminal B and the terminal C. First, processing when the terminal A sends the HoT ring message and the CoT ring message will be described. Ring Tokens are generated in a Token generation unit 201. Nonces used for Token generation are managed and stored in a Nonce management unit 202.

A message creation unit 203 creates a HoT ring message and a CoT ring message to which Ring Data and Ring Tokens for the terminal B and the terminal C are added, respectively, and a message transmitting unit 204 sends the HoT ring message and the CoT ring message. Ring Data is acquired from a Ring Data creation unit 205.

Next, processing when the HoT ring message and CoT ring message passed back have been received will be described. The ring messages are received at a message receiving unit 206, Ring Tokens addressed to its own terminal are stored in a Ring Token storage unit 207. If any forwarding destination of the ring messages remains, messages are created in the message creation unit 203 and sent from the message transmitting unit 204. When both Tokens, Home Token and Care-of Token, are gathered in the Ring Token storage unit 207, key data is generated in a Key generation unit 208, and a message authentication code is generated based on message data in a message authentication code generating unit 209. The generated message authentication code is added to the BU message in the message creation unit 203, and sent from the message transmitting unit 204.

Since the following is the same as normal MIP binding update processing, a brief description will be given. When receiving a HoTI/CoTI message at the message receiving unit 206, Tokens are generated in the Token generation unit 201, a response message is created in the message creation unit 203, and the created message is sent from the message transmitting unit 204. Nonces used upon Token generation are stored and managed in the Nonce management unit 202.

Further, processing when receiving a BU message will be described. When receiving the BU message, Home Token and Care-of Token are generated in the Token generation unit 201 using addresses and Nonce-IDs included. Using the generated Tokens, key data is generated in the Key generation unit 208, and using the key data and the message data, a message authentication code is generated in the message authentication code generating unit 209. Then, in a message authentication code comparing unit 210, the generated message authentication code is compared with a message authentication code added to the BU message, and if they match, a binding cache is registered in a binding cache management unit 211. Based on the comparison result in the message authentication code comparing unit 210, a forwarding of ring message determining unit 212 determines whether to forward the ring message. The Token storage unit for forwarding determination 213 is to store Tokens used in the forwarding determination.

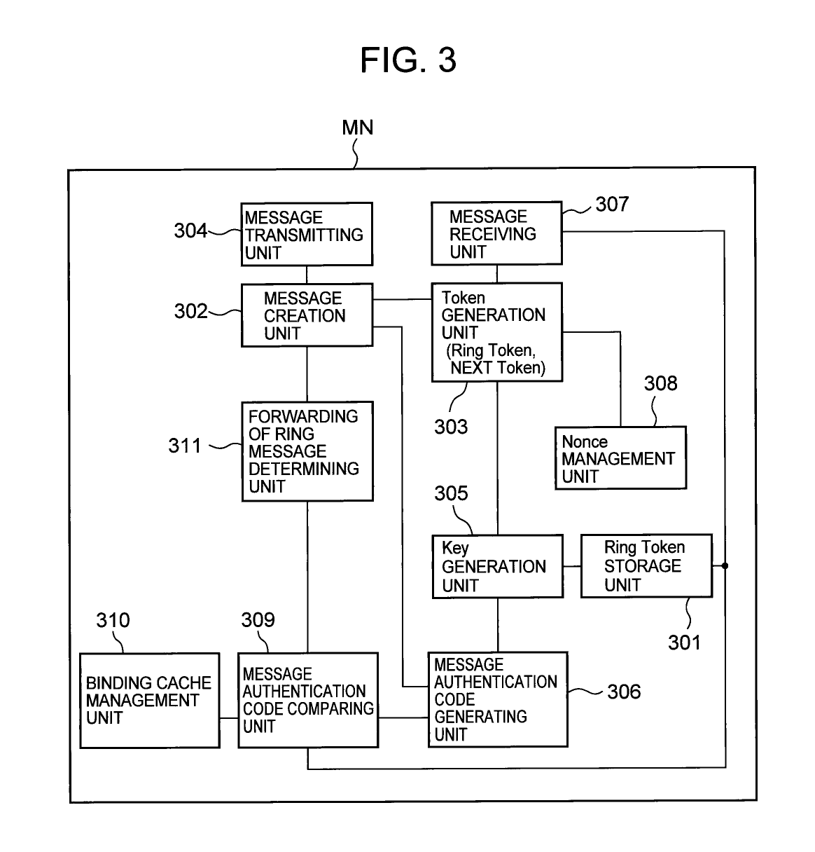

Referring next to FIG. 3, a mobile terminal on the side of participating in ring binding update will be described. Here, the terminal B is taken as an example in which the terminal A performs ring binding update to the terminal B and the terminal C, and the terminal B performs ring binding update to the terminal A and the terminal C. First, processing when receiving a HoT ring message or CoT ring message from the terminal A will be described. When receiving the ring message, the terminal B stores, in a Ring Token storage unit 301, Ring Tokens included in the ring message and addressed to its own terminal.

A message creation unit 302 adds, to a ring message to be forwarded, Ring Tokens addressed to forwarding destination terminals (here, terminal C and terminal A) generated in a Token generation unit 303, and sent from a message transmitting unit 304. After receiving the ring message, when both HoT Ring Token and CoT Ring Token are gathered, key data is generated in a Key generation unit 305 to create a BU message, a message authentication code is generated in a message authentication code generating unit 306, the generated message authentication code is added to the BU message in the message creation unit 302, and the BU message is sent from the message transmitting unit 304.

Since the following is the same as normal MIP binding update processing, a brief description will be given. When receiving a HoTI/CoTI message at a message receiving unit 307, Tokens are generated in the Token generation unit 303, a response message is created in the message creation unit 302, and the created message is sent from the message transmitting unit 304. Nonces used upon Token generation are stored and managed in a Nonce management unit 308.

Further, processing when receiving a BU message will be described. When receiving the BU message, Home Token and Care-of Token are generated in the Token generation unit 303 using addresses and Nonce-IDs included. Using the generated Tokens, key data is generated in the Key generation unit 305, and using the key data and the message data, a message authentication code is generated in the message authentication code generating unit 306. Then, in a message authentication code comparing unit 309, the generated message authentication code is compared with a message authentication code added to the BU message, and if they match, a binding cache is registered in a binding cache management unit 310. Based on the comparison result in the message authentication code comparing unit 309, a forwarding of ring message determining unit 311 determines whether to forward the ring message.

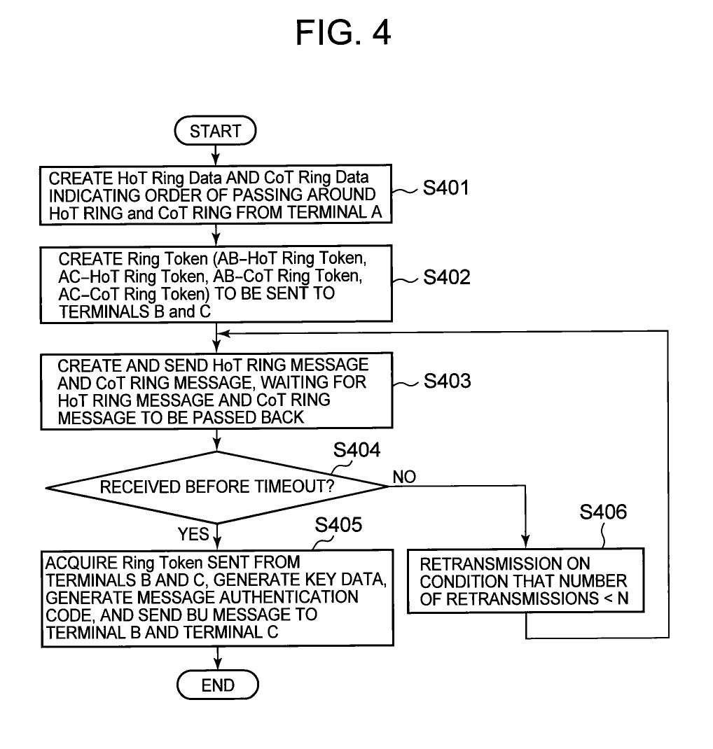

Referring next to FIG. 4, a processing flow in a mobile terminal on the side of initiating ring binding update will be described. As shown in FIG. 4, the terminal A creates HoT Ring Data and CoT Ring Data indicating the order of passing around the HoT ring message and CoT ring message from the terminal A, respectively (step S401). The terminal A generates Ring Tokens (AB-HoT Ring Token, AC-HoT Ring Token, AB-CoT Ring Token, AC-CoT Ring Token) to be sent to the terminal B and the terminal C (step S402). Next, the terminal A creates and sends a HoT ring message and a CoT ring message, waiting for the HoT ring message and CoT ring message to be passed back (step S403).

The terminal A determines whether messages are received before a predetermined timeout (step S404). If received before the timeout, the terminal A acquires Ring Tokens sent from the terminal B and the terminal C, generates key data, generates a message authentication code, and sends a BU message to the terminal B and the terminal C (step S405). On the other hand, in step S404, if not received before the timeout, the terminal A performs retransmission on condition that the number of retransmissions is smaller than a predetermined value N (step S406).

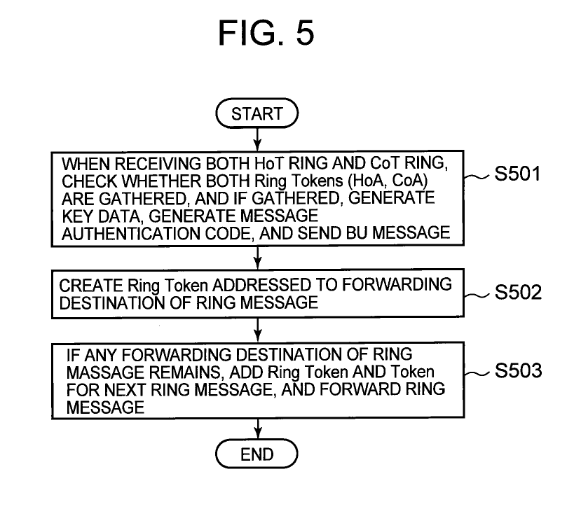

Referring next to FIG. 5, a processing flow in a mobile terminal on the side of participating in ring binding update will be described. As shown in FIG. 5, when the terminal B has received both the HoT ring message and the CoT ring message, for example, the terminal B checks whether both Ring Tokens (HoA, CoA) are gathered. If gathered, the terminal B generates key data, generates a message authentication code, and sends a BU message (step S501). Then, the terminal B generates Ring Tokens addressed to forwarding destinations of the ring messages (step S502). If any forwarding destination of the ring messages remains, the terminal B adds Ring Tokens and Tokens for the next ring messages, and forwards the ring messages (step S503).

### Second Embodiment

A second embodiment will be described. In the first embodiment, since the HoT ring message and the CoT ring message are sent to the same terminals (in the same direction), a situation arises in which other terminals that receive these messages have access to information for generating key data. For example, since the information Ac1 and Ac2 sent from the terminal A to the terminal C is also delivered to the terminal B as well as the terminal C, the terminal B can pretend to be the terminal C to generate key data (Key(Ac1, Ac2)). The following describes a method of avoiding this situation to improve security.

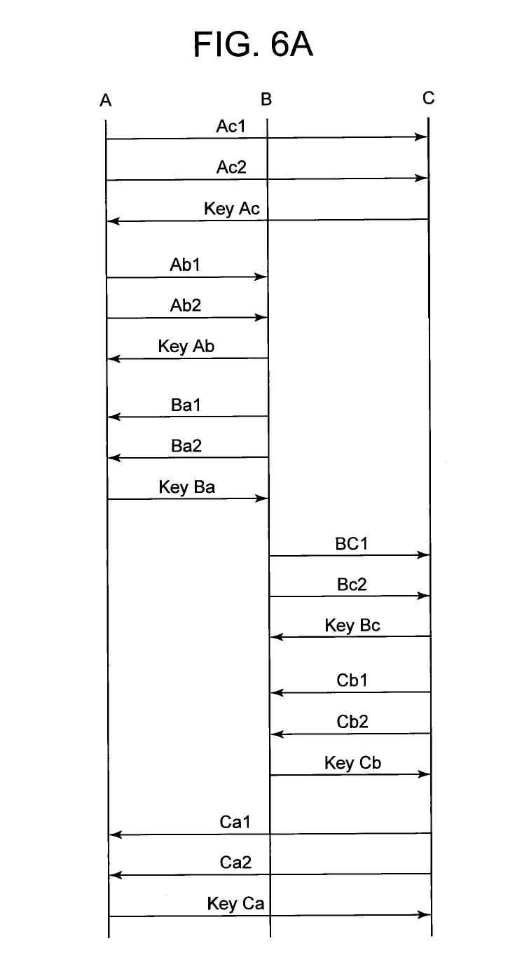

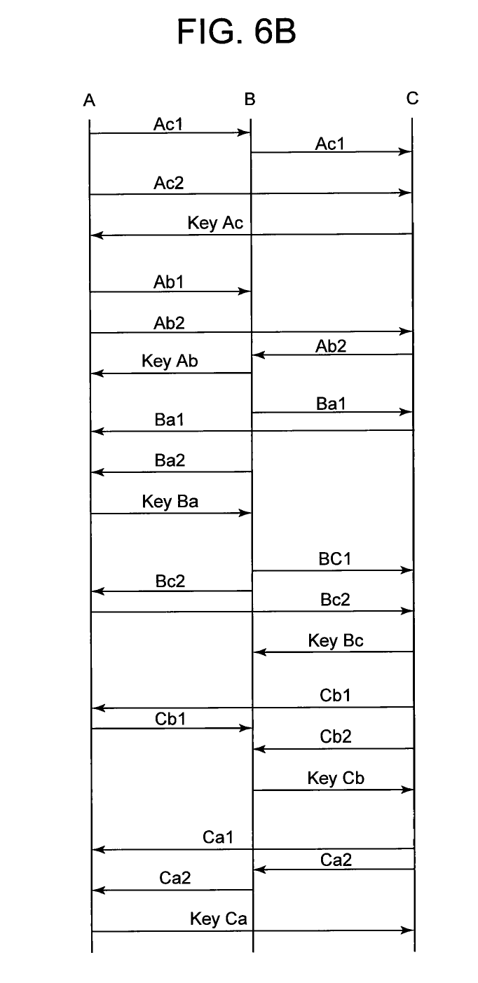

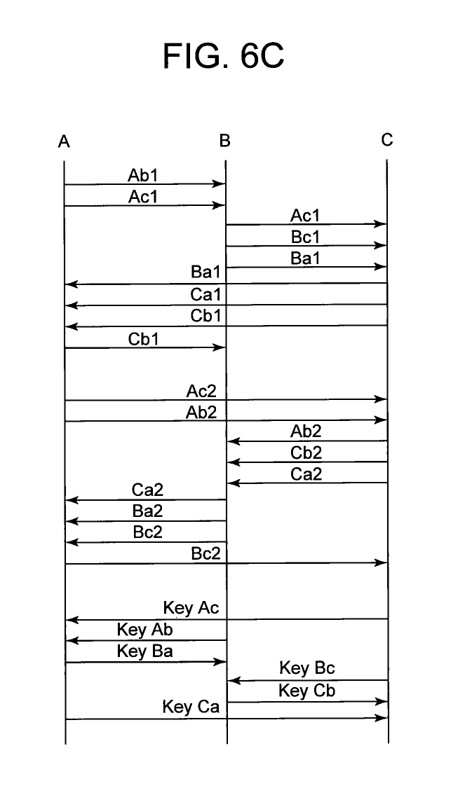

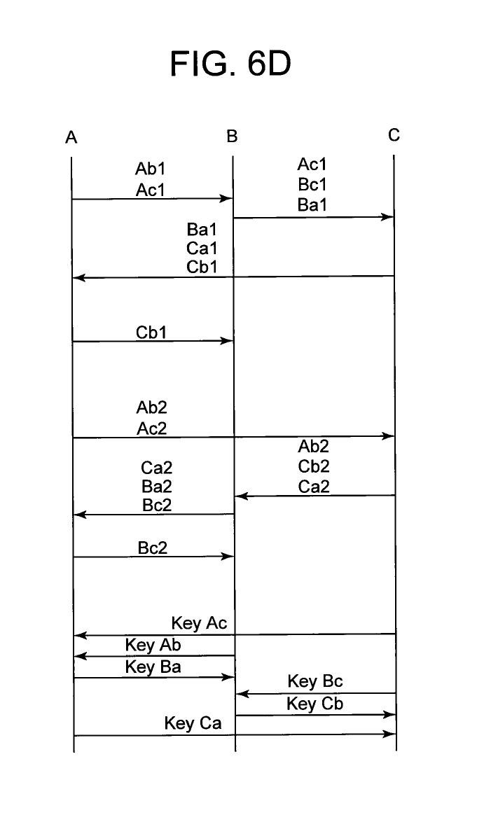

In a method shown in FIG. 6D, the HoT ring message from the terminal A to the terminal C is once sent to the terminal B, and sent from the terminal B to the terminal C. On the other hand, the CoT ring message is not forwarded to the terminal B. Therefore, among Home Token and Care-of Token generated to be addressed to the terminal C, the terminal B has access to one (here, HoT ring message) but does not have access to both, so that the terminal B cannot pretend to be the terminal C to generate key data.

Similarly, either one of the HoT ring message and the CoT ring message from the terminal A to the terminal B is sent via the terminal C. Here, considering that the HoT ring message from the terminal A to the terminal C is forwarded via the terminal B, it is assumed that the HoT ring message from the terminal A to the terminal B is sent directly to the terminal B while forwarding the CoT ring message to the terminal B via the terminal C. The terminal B relays the HoT ring message from the terminal A to the terminal C. Upon forwarding the HoT ring message, the terminal B overlaps a HoT ring message created by the terminal B for the terminal C, and sends the HoT ring message. Along with this, the CoT ring message from the terminal B to the terminal C is forwarded via the terminal A.

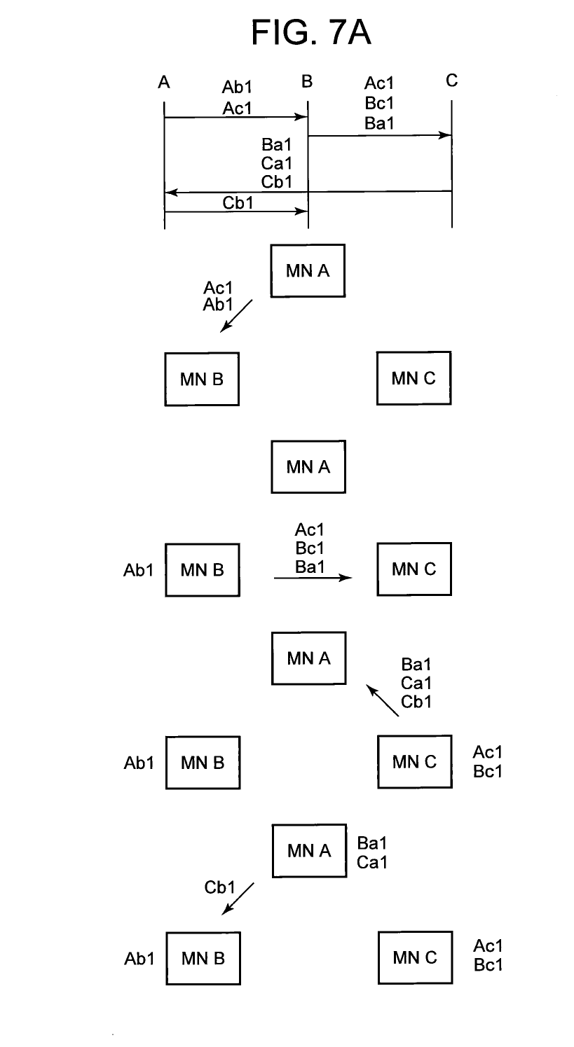

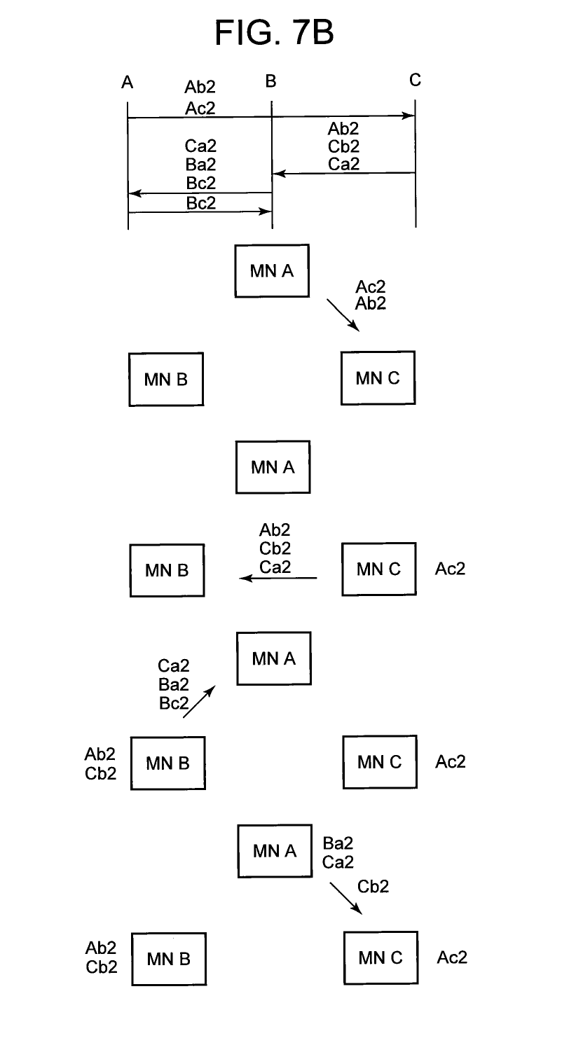

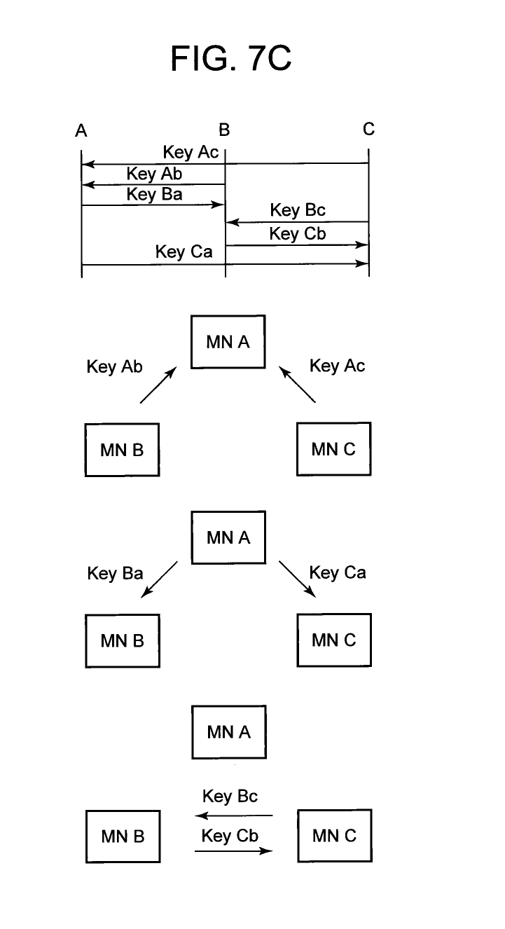

The HoT ring message from the terminal B to the terminal A is sent via the terminal C along with the HoT ring message from the terminal B to the terminal C. A flow of messages in FIG. 6D can be represented as shown in FIG. 7A to FIG. 7C. In other words, the HoT ring message is passed around in the direction of terminal A→terminal B→terminal C, and the CoT ring message is passed around reversely in the direction of the terminal A→terminal C→terminal B. Thus, the HoT ring message and the CoT ring message are passed around in opposite directions, and this has the advantage that both Home Token and Care-of Token addressed to the terminal A are not gathered at the terminal B or the terminal C.

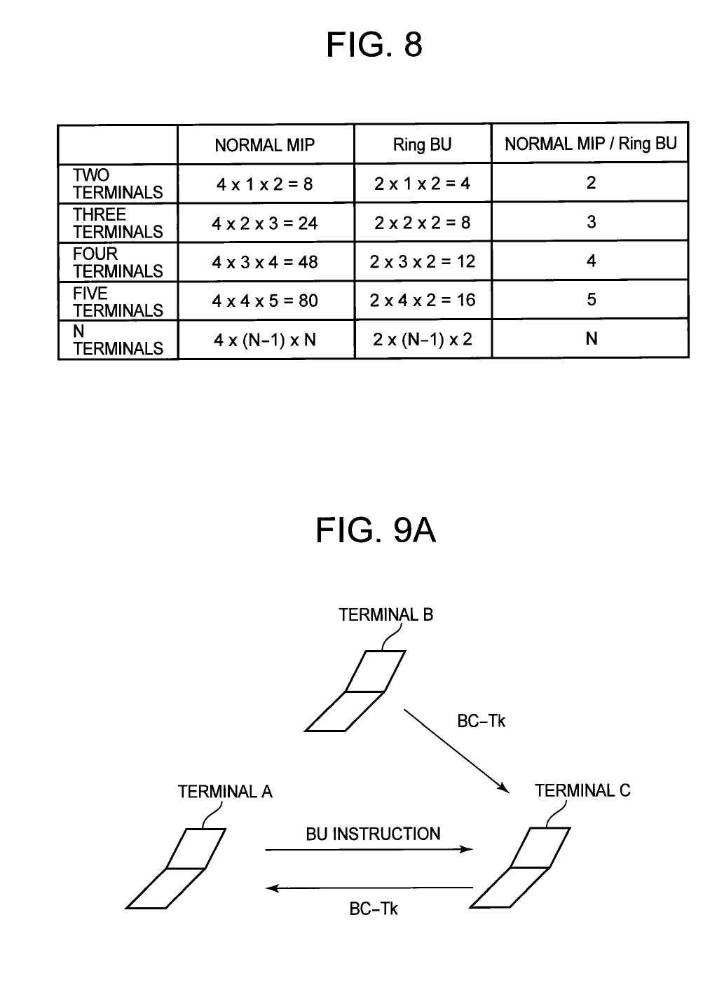

The first and second embodiments, and subsequent embodiments to be described later, show that the use of the HoT ring message and the CoT ring message can reduce the number of messages when multiple terminals are performing binding update to one another, compared with a case where they are performing binding update independently. The effect of reduction in the number of messages can be shown in FIG. 8 in comparison with the number of messages necessary for Return Routability processing. In the case of N terminals, the number of messages can be reduced to one-Nth.

Here, a description is given to illustrate how to calculate the number of messages required for RR (Return Routability) processing in the case of normal MIP. One terminal sends one correspondent terminal four messages, HoTI, HoT, CoTI and CoT. Since N−1 correspondent terminals exist, the number of messages (four) is multiplied by (N−1). Further, since N terminals exist in total, the multiplication result is multiplied by N. On the other hand, the following describes how to calculate the number of messages required for RR (Return Routability) processing in the case of Ring BU. HoTI is passed around in the form of a ring. In this case, if the number of the terminals is N, N−1 messages are required until Tokens added by the first terminal is delivered to the last terminal. In addition, N−1 messages are further required until the last terminal adds Tokens to complete the delivery of the Tokens. Similarly, in the case of CoTI, 2×(N−1) messages are required, the multiplication result is doubled.

In addition to the use of the HoT ring message and the CoT ring message, which can result in reduction in the number of messages, the directions to pass around the HoT ring message and CoT ring message are reversed in the second embodiment and the like, so that only the source terminal and the destination terminal can receive Home Token and Care-of Token, thereby preventing any other terminals from generating key data, and hence improving security.

Here, the second embodiment will be described in more detail, i.e., the case where the HoT ring message and the CoT ring message are passed around in the opposite directions will be described. The terminal A decides to pass around the HoT ring message or the CoT ring message to the terminal B first and the terminal C next (terminal A→terminal B→terminal C), and creates Ring Data as shown below. This Ring Data is added to the ring message, so that the receiving terminal can know to which terminal it sends the ring message next. The receiving terminal can also decide on Tokens to be added to the ring message. The HoT ring message and the CoT ring message are sent in the opposite directions to limit the number of terminals, where both Home Token and Care-of Token are gathered, to only the source terminal and the destination terminal.

HoT Ring Data=(B-Home Address, C-Home Address, A-Home Address)

CoT Ring Data=(C-Care-of Address, B-Care-of Address, A-Care-of Address)

Next, the terminal A generates Tokens to be sent to the terminal B and the terminal C. These Tokens are called HoT Ring Token and CoT Ring Token. The following is Ring Tokens to be generated:

AB-HoT Ring Token=SHA1 (B-Home Address, A's secret key, AB-HoT ring nonce)

AC-HoT Ring Token=SHA1 (C-Home Address, A's secret key, AC-HoT ring nonce)

AB-CoT Ring Token=SHA1 (B-Care-of Address, A's secret key, AB-CoT ring nonce)

AC-CoT Ring Token=SHA1 (C-Care-of Address, A's secret key, AC-CoT ring nonce)

Using these pieces of information, the terminal A creates a HoT ring message and a CoT ring message. The following information is added to the HoT ring message:

B-Home Address, AB-HoT Ring Token, AB-HoT ring nonce

C-Home Address, AC-HoT Ring Token, AC-HoT ring nonce

HoT Ring Data

Further, the following information is added to the CoT ring message:

C-Care-of Address, AC-CoT Ring Token, AC-CoT ring nonce

B-Care-of Address, AB-CoT Ring Token, AB-CoT ring nonce

CoT Ring Data

Then, the terminal A sends the HoT ring message to Home Address of the terminal B. The terminal A also sends the CoT ring message to Care-of Address of the terminal C.

Next, HoT ring processing at the terminal B will be described. When receiving the HoT ring message, the terminal B holds Ring Tokens addressed to the terminal B. In other words, the terminal B holds B-Home Address, AB-HoT Ring Token and AB-HoT ring nonce. Before starting the HoT ring processing, the terminal B may check the presence of a binding cache between the terminal B and the terminal A. Then, the terminal B generates HoT Ring Tokens, i.e., the following information:

BC-HoT Ring Token=SHA1 (C-Home Address, B's secret key, BC-HoT ring nonce)

BA-HoT Ring Token=SHA1 (A-Home Address, B's secret key, BA-HoT ring nonce)

Then, the terminal B adds, to the HoT ring message, the following information:

C-Home Address, BC-HoT Ring Token, BC-HoT ring nonce

A-Home Address, BA-HoT Ring Token, BA-HoT ring nonce

Information included in the HoT ring message to be sent from the terminal B to the terminal C in the above processing is the following information:

C-Home Address, AC-HoT Ring Token, AC-HoT ring nonce (information from the terminal A)

C-Home Address, BC-HoT Ring Token, BC-HoT ring nonce (added by the terminal B)

A-Home Address, BA-HoT Ring Token, BA-HoT ring nonce (added by the terminal B)

HoT Ring Data

Next, HoT ring processing at the terminal C will be described. When receiving the HoT ring message, the terminal C holds Ring Tokens addressed to the terminal C. In other words, the terminal C holds the following information:

C-Home Address, AC-HoT Ring Token, AC-HoT ring nonce

C-Home Address, BC-HoT Ring Token, BC-HoT ring nonce

The terminal C generates the following HoT Ring Tokens:

CA-HoT Ring Token=SHA1 (A-Home Address, C's secret key, CA-HoT ring nonce)

CB-HoT Ring Token=SHA1 (B-Home Address, C's secret key, CB-HoT ring nonce)

Then, the terminal C adds, to the HoT ring message, the following information:

A-Home Address, CA-HoT Ring Token, CA-HoT ring nonce

B-Home Address, CB-HoT Ring Token, CB-HoT ring nonce

Information included in the HoT ring message to be sent from the terminal C to the terminal A is the following information:

A-Home Address, BA-HoT Ring Token, BA-HoT ring nonce (information from the terminal B)

A-Home Address, CA-HoT Ring Token, CA-HoT ring nonce (added by the terminal C)

B-Home Address, CB-HoT Ring Token, CB-HoT ring nonce (added by the terminal C)

HoT Ring Data

Next, HoT ring processing at the terminal A will be described. When receiving the HoT ring message, the terminal A holds Ring Tokens addressed to the terminal A. In other words, the terminal A holds the following information:

A-Home Address, BA-HoT Ring Token, BA-HoT ring nonce

A-Home Address, CA-HoT Ring Token, CA-HoT ring nonce

Information included in the HoT ring message to be sent from the terminal A to the terminal B in the above processing is the following information:

B-Home Address, CB-HoT Ring Token, CB-HoT ring nonce (added by the terminal C)

Next, CoT ring processing at the terminal C will be described. The HoT ring processing is almost the same processing as well. When receiving the CoT ring message, the terminal C holds Ring Token addressed to the terminal C. In other words, the terminal C holds the following information:

C-Care-of Address, AC-CoT Ring Token, AC-CoT ring nonce

The terminal C generates the following CoT Ring Tokens:

CB-CoT Ring Token=SHA1 (B-Care-of Address, C's secret key, CB-CoT ring nonce)

CA-CoT Ring Token=SHA1 (A-Care-of Address, C's secret key, CA-CoT ring nonce)

Then, the terminal C adds, to the CoT ring message, the following information:

B-Care-of Address, CB-CoT Ring Token, CB-CoT ring nonce

A-Care-of Address, CA-CoT Ring Token, CA-CoT ring nonce

Information included in the CoT ring message to be sent from the terminal C to the terminal B in the above processing is the following information:

B-Care-of Address, AB-CoT Ring Token, AB-CoT ring nonce (information from the terminal A)

B-Care-of Address, CB-CoT Ring Token, CB-CoT ring nonce (added by the terminal C)

A-Care-of Address, CA-CoT Ring Token, CA-CoT ring nonce (added by the terminal C)

CoT Ring Data

Next, CoT ring processing at the terminal B will be described. When receiving the CoT ring message, the terminal B holds Ring Tokens addressed to the terminal B. In other words, the terminal B holds the following information:

B-Care-of Address, AB-CoT Ring Token, AB-CoT ring nonce

B-Care-of Address, CB-CoT Ring Token, CB-CoT ring nonce

The terminal B generates the following CoT Ring Tokens:

BA-CoT Ring Token=SHA1 (A-Care-of Address, B's secret key, BA-CoT ring nonce)

BC-CoT Ring Token=SHA1 (C-Care-of Address, B's secret key, BC-CoT ring nonce)

Then, the terminal B adds, to the CoT ring message, the following information:

A-Care-of Address, BA-CoT Ring Token, BA-CoT ring nonce

C-Care-of Address, BC-CoT Ring Token, BC-CoT ring nonce

Information included in the CoT ring message to be sent from the terminal B to the terminal A in the above processing is the following information:

A-Care-of Address, CA-CoT Ring Token, CA-CoT ring nonce (information from the terminal C)

A-Care-of Address, BA-CoT Ring Token, BA-CoT ring nonce (added by the terminal B)

C-Care-of Address, BC-CoT Ring Token, BC-CoT ring nonce (added by the terminal B)

CoT Ring Data

Next, CoT ring processing at the terminal A will be described. When receiving the CoT ring message, the terminal A holds Ring Tokens addressed to the terminal A. In other words, the terminal A holds the following information:

A-Care-of Address, CA-CoT Ring Token, CA-CoT ring nonce

A-Care-of Address, BA-CoT Ring Token, BA-CoT ring nonce

Information included in the CoT ring message to be sent from the terminal A to the terminal C in the above processing is the following information:

C-Care-of Address, BC-CoT Ring Token, BC-CoT ring nonce (information from the terminal B)

Next, the operation of terminals when receiving both the HoT ring message and the CoT ring message will be described. The terminal B acquires the following information from the HoT ring message:

B-Home Address, AB-HoT Ring Token, AB-HoT ring nonce

B-Home Address, CB-HoT Ring Token, CB-HoT ring nonce

The terminal B also acquires the following information from the CoT ring message:

B-Care-of Address, AB-CoT Ring Token, AB-CoT ring nonce

B-Care-of Address, CB-CoT Ring Token, CB-CoT ring nonce

Using these Tokens, the terminal B generates Key as the following key data:

AB-Key=SHA1 (AB-HoT Ring Token, AB-CoT Ring Token)

CB-Key=SHA1 (CB-HoT Ring Token, CB-CoT Ring Token)

Then, using these Keys, the terminal B generates an authentication code, and sends the terminal A a BU message to which AB-HoT ring nonce and AB-CoT ring nonce are added together with the generated authentication code and the like. The terminal B also sends the terminal C a BU message to which CB-HoT ring nonce and CB-CoT ring nonce are added together with the generated authentication code and the like.

On the other hand, the terminal C acquires the following information from the HoT ring message:

C-Home Address, AC-HoT Ring Token, AC-HoT ring nonce

C-Home Address, BC-HoT Ring Token, BC-HoT ring nonce

The terminal C also acquires the following information from the CoT ring message:

C-Care-of Address, AC-CoT Ring Token, AC-CoT ring nonce

C-Care-of Address, BC-CoT Ring Token, BC-CoT ring nonce

Using these Tokens, the terminal C generates Key as key data.

AC-Key=SHA1 (AC-HoT Ring Token, AC-CoT Ring Token)

BC-Key=SHA1 (BC-HoT Ring Token, BC-CoT Ring Token)

Then, using these Keys, the terminal C generates an authentication code, and sends the terminal A a BU message to which AC-HoT ring nonce and AC-CoT ring nonce are added together with the generated authentication code and the like. The terminal C also sends the terminal B a BU message to which BC-HoT ring nonce and BC-CoT ring nonce are added together with the generated authentication code and the like.

On the other hand, the terminal A acquires the following information from the HoT ring message:

A-Home Address, BA-HoT Ring Token, BA-HoT ring nonce

A-Home Address, CA-HoT Ring Token, CA-HoT ring nonce

The terminal A also acquires the following information from the CoT ring message:

A-Care-of Address, CA-CoT Ring Token, CA-CoT ring nonce

A-Care-of Address, BA-CoT Ring Token, BA-CoT ring nonce

Using these Tokens, the terminal A generates Key as key data.

BA-Key=SHA1 (BA-HoT Ring Token, BA-CoT Ring Token)

CA-Key=SHA1 (CA-HoT Ring Token, CA-CoT Ring Token)

Then, using these Keys, the terminal A generates an authentication code, and sends the terminal B a BU message to which BA-HoT ring nonce and BA-CoT ring nonce are added together with the generated authentication code and the like. The terminal A also sends the terminal C a BU message to which CA-HoT ring nonce and CA-CoT ring nonce are added together with the generated authentication code and the like. The same processing can be performed even in a case where the number of the terminals is four or more. For example, when the number of the terminals is four, the terminal A sets Ring Data in such a manner that the HoT ring message is delivered to terminal B, terminal C and terminal D in this order and the CoT ring message is delivered to terminal D, terminal C and terminal B in this order.

Next, a mobile the terminal on the side of initiating the above-mentioned ring binding update will be described. Note that the configuration of the mobile terminal is the same as that shown in FIG. 2 mentioned above. Therefore, the description will be given with reference to FIG. 2. Here, the terminal A is taken as an example to describe a case where the terminal A performs ring binding update to the terminal B and the terminal C. First, processing for sending the HoT ring message and the CoT ring message will be described.

The Token generation unit 201 generates Ring Tokens. Nonces used for Token generation are managed and stored in the Nonce management unit 202. The message creation unit 203 acquires Ring Data from the Ring Data creation unit 205, and acquires Ring Tokens from the Token generation unit 201. Then, the HoT ring message and CoT ring message added these pieces of information are created, and created messages are sent from the message transmitting unit 204.

Next, processing after receiving the HoT ring message and the CoT ring message passed back will be described. The ring message is received at the message receiving unit 206, and Ring Tokens addressed to its own terminal are stored in the Ring Token storage unit 207. If any forwarding destination remains, Ring Tokens are generated in the Token generation unit 201, a ring message to be forwarded is created in the message creation unit 203, and the ring message is sent from the message transmitting unit 204.

When both Tokens, Home Token and Care-of Token, are gathered in the Ring Token storage unit 207, key data is generated in a Key generation unit 208, and a message authentication code is generated based on message data in the message authentication code generating unit 209. The generated message authentication code is added to the BU message in the message creation unit 203, and sent from the message transmitting unit 204.

Since the following is the same as normal MIP binding update processing, a brief description will be given. When receiving a HoTI/CoTI message at the message receiving unit 206, Tokens are generated in the Token generation unit 201, a response message is created in the message creation unit 203, and the created message is sent from the message transmitting unit 204. Nonces used upon Token generation are stored and managed in the Nonce management unit 202.

Further, processing when receiving a BU message will be described. When receiving the BU message, Home Token and Care-of Token are generated in the Token generation unit 201 using addresses and Nonce-IDs included. Using the generated Tokens, key data is generated in the Key generation unit 208, and using the key data and the message data, a message authentication code is generated in the message authentication code generating unit 209. Then, in the message authentication code comparing unit 210, the generated message authentication code is compared with a message authentication code added to the BU message, and if they match, a binding cache is registered in the binding cache management unit 211. Based on the comparison result in the message authentication code comparing unit 210, the forwarding of ring message determining unit 212 determines whether to forward the ring message. The Token storage unit for forwarding determination 213 is to store Tokens used in the forwarding determination.

Next, a mobile terminal on the side of participating in ring binding update will be described. Since the configuration of the mobile terminal is the same as that shown in FIG. 3, the description will be given with reference to FIG. 3. Further, the terminal B is taken as an example here. In other words, the description is given of the terminal B when the terminal A performs ring binding update to the terminal B and the terminal C. First, processing after receiving the HoT ring message or the CoT ring message from the terminal A will be described.

When receiving the ring message, the terminal B stores, in the Ring Token storage unit 301, Ring Tokens included in the ring message and addressed to its own terminal. The message creation unit 302 adds, to a ring message to be forwarded, Ring Tokens addressed to forwarding destination terminals generated in the Token generation unit 303. Then, the ring message is sent from the message transmitting unit 304. After receiving the ring message, when both HoT Ring Token and CoT Ring Token are gathered, key data is generated in the Key generation unit 305 to create a BU message, a message authentication code is generated in the message authentication code generating unit 306, the generated message authentication code is added to the BU message in the message creation unit 302, and the BU message is sent from the message transmitting unit 304.

Since the following is the same as normal MIP binding update processing, a brief description will be given. When receiving a HoTI/CoTI message at the message receiving unit 307, Tokens are generated in the Token generation unit 303, a response message is created in the message creation unit 302, and the created message is sent from the message transmitting unit 304. Nonces used upon Token generation are stored and managed in the Nonce management unit 308.

Next, processing after receiving the BU message will be described. When receiving the BU message, Home Token and Care-of Token are generated in the Token generation unit 303 using addresses and Nonce-IDs included. Using the generated Tokens, key data is generated in the Key generation unit 305, and using the key data and the message data, a message authentication code is generated in the message authentication code generating unit 306. Then, in the message authentication code comparing unit 309, the generated message authentication code is compared with a message authentication code added to the BU message, and if they match, a binding cache is registered in the binding cache management unit 310. Based on the comparison result in the message authentication code comparing unit 309, the forwarding of ring message determining unit 311 determines whether to forward the ring message.

Next, a processing flow in a mobile terminal on the side of initiating ring binding update will be described. The processing flow in the mobile terminal here is the same as that shown in FIG. 4, the following description is made with reference to FIG. 4. As shown in FIG. 4, the terminal A creates HoT Ring Data and CoT Ring Data indicating the order of passing around the HoT ring message and CoT ring message from the terminal A, respectively (step S401). The terminal A generates Ring Tokens (AB-HoT Ring Token, AC-HoT Ring Token, AB-CoT Ring Token, AC-CoT Ring Token) to be sent to the terminal B and the terminal C (step S402). Next, the terminal A creates and sends a HoT ring message and a CoT ring message, waiting for the HoT ring message and CoT ring message to be passed back (step S403).

The terminal A determines whether messages are received before a predetermined timeout (step S404). If received before the timeout, the terminal A acquires Ring Tokens sent from the terminal B and the terminal C, generates key data, generates a message authentication code, and sends a BU message to the terminal B and the terminal C (step S405). On the other hand, in step S404, if not received before the timeout, the terminal A performs retransmission on condition that the number of retransmissions is smaller than a predetermined value N (step S406).

Next, a processing flow in a mobile terminal on the side of participating in ring binding update will be described. Since the processing flow in the mobile terminal here is the same as that shown in FIG. 5, the description will be given with reference to FIG. 5. As shown in FIG. 5, when the terminal B has received both the HoT ring message and the CoT ring message, for example, the terminal B checks whether both Ring Tokens (HoA, CoA) are gathered. If gathered, the terminal B generates key data, generates a message authentication code, and sends a BU message (step S501). Then, the terminal B generates Ring Tokens addressed to the forwarding destinations of the ring messages (step S502). If any forwarding destination of the ring messages remains, the terminal B adds Ring Tokens for the forwarding destination terminal and forwards the ring messages (step S503).

### Third Embodiment

A third embodiment will be described. Here, a description will be given of a criterion for forwarding the HoT ring message or CoT ring message. The terminal B or the terminal C that has received the HoT ring message or the CoT ring message sent by the terminal A forwards the HoT ring message or the CoT ring message toward a terminal as the next forwarding destination described in the message. Therefore, it is considered that if the address of the forwarding destination is wrong, the message may be forwarded to the wrong address.

Upon forwarding the HoT ring message/CoT ring message, a criterion as to whether the terminal B has a binding cache relating to the terminal A and the terminal C can be used to determine whether to forward the message. This can significantly limit the number of terminals to which the terminal B forwards the message. The following describes a method of making a secure forwarding determination.

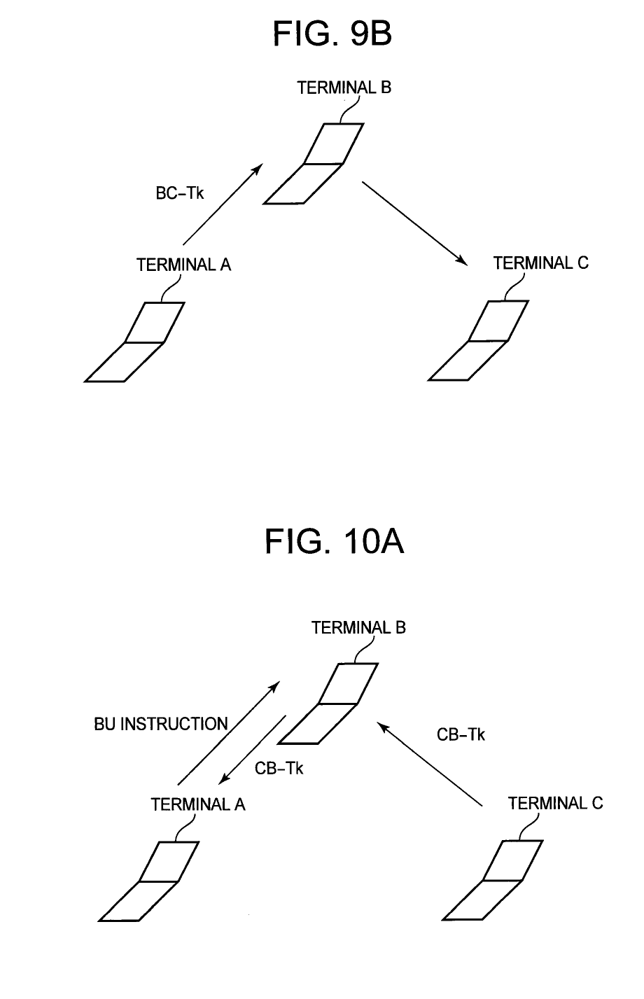

Suppose that the terminal A has already performed binding update to the terminal B and the terminal C, and the terminal B and the terminal C has already performed binding update to the terminal A. In this case, if the terminal B and the terminal C have performed binding update to each other, the terminal A determines that binding update among the three terminals is possible, and instructs the terminal C to perform binding update to the terminal B as shown in FIG. 9A. Then, the terminal A requests the terminal C to forward, to the terminal A, Home Token and Care-of Token (BC-Token) sent from the terminal B to the terminal C.

When Home Token and Care-of Token are sent from the terminal B to the terminal C, the terminal B sends them to the HoA and the CoA, separately. Like in the second embodiment, this is done on condition that only the terminal C can have both Tokens. Similarly, when Tokens are sent from the terminal C to the terminal A, the terminal C also sends Home Token and Care-of Token to the HoA and the CoA of the terminal A, separately. As shown in FIG. 9B, when sending the HoT ring message to the terminal B, the terminal A adds an authentication code as shown below. The authentication code is an authentication code MAC generated using key data (here, BC-Key) generated from Tokens sent from the terminal B to the terminal C.

BC-Key=SHA1 (BC-Home Token, BC-Care-of Token)

MAC=SHA1 (BC-Key, Data)

The terminal B generates BC-Home Token and BC-Care-of Token from home-nonce and care-of nonce included in the HoT ring message, and Home Address and Care-of Address of the terminal C as the forwarding destination, respectively.

BC-Home Token=SHA1 (C-HoA, B's secret key, home nonce)

BC-Care-of Token=SHA1 (C-CoA, B's secret key, care-of nonce)

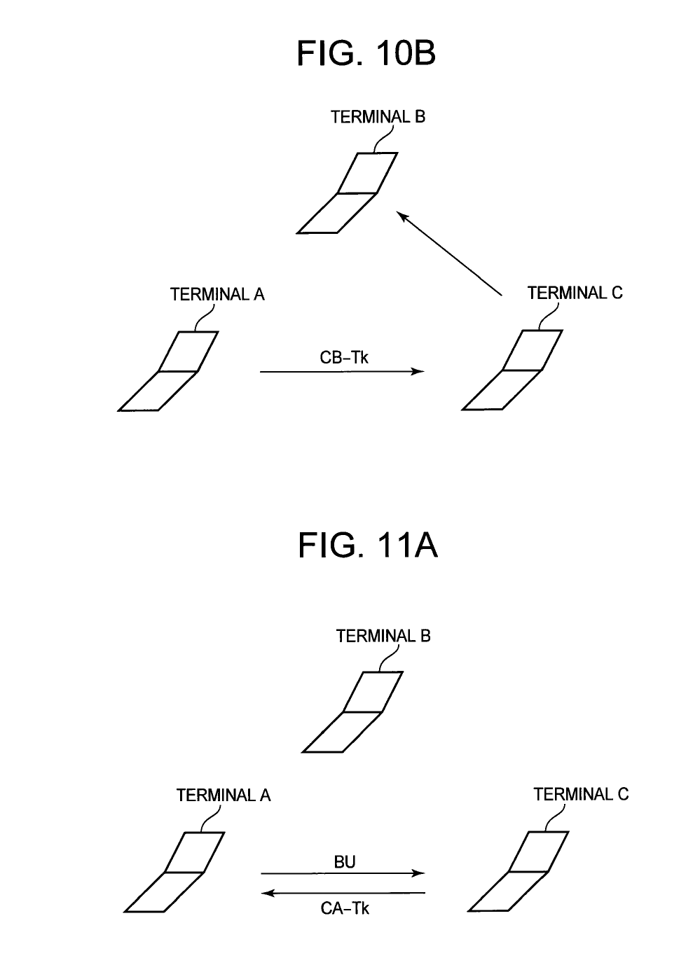

Further, the terminal B generates BC-Key from these Tokens and checks whether MAC is correct. Here, only the terminal C can have both Tokens, and the request is originated from the terminal C as the correspondent terminal to which Tokens were passed. Therefore, the terminal B determines that forwarding from the terminal B to the terminal C is permitted by the terminal C. Similarly, in the case of the CoT ring message, as shown in FIG. 10A and FIG. 10B, the terminal A instructs the terminal B to perform binding update to the terminal C so as to request Token (CB-Token) sent from the terminal C to the terminal B.

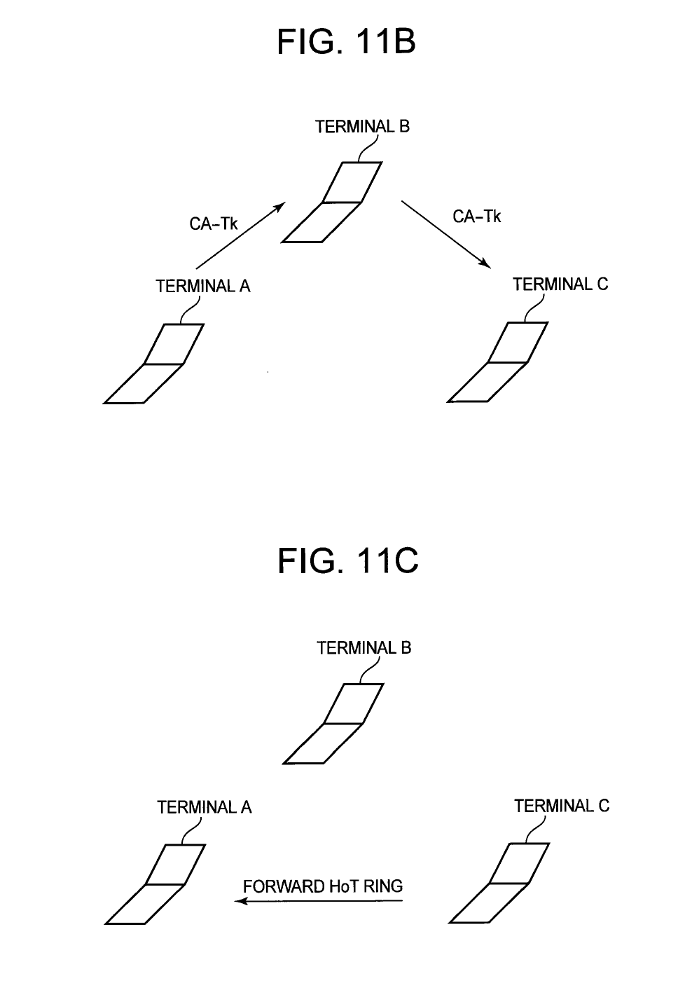

Referring next to FIG. 11A to FIG. 11C, forwarding determination processing for the HoT ring message at the terminal C to forward the HoT ring message to the terminal A when the HoT ring message sent by the terminal A has reached the terminal C via the terminal B will be described. As shown in FIGS. 11A and 11B, the terminal A generates Keys from Home Token and Care-of Token (CA-Token) acquired as a result of binding update with the terminal C, adds the authentication code generated based on the Keys to the HoT ring message, and sends the HoT ring message. The authentication code is delivered to the terminal C via the terminal B.

Using home nonce and care-of nonce included in the HoT ring message, the terminal C generates the following Home Token and Care-of token:

CA-Home Token=SHA1 (A-HoA, C's secret key, home nonce)

CA-Care-of Token=SHA1 (A-CoA, C's secret key, care-of nonce)

Further, the terminal C generates the following Key and authentication code MAC:

Key=SHA1 (CA-Home Token, CA-Care-of Token)

MAC=SHA1 (Key, Data)

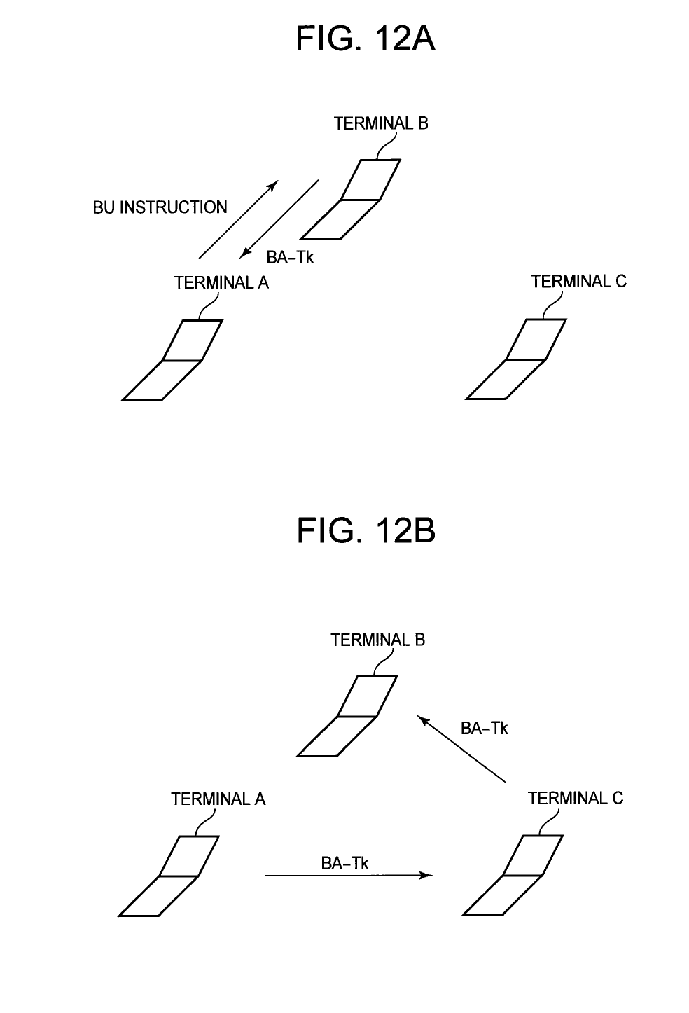

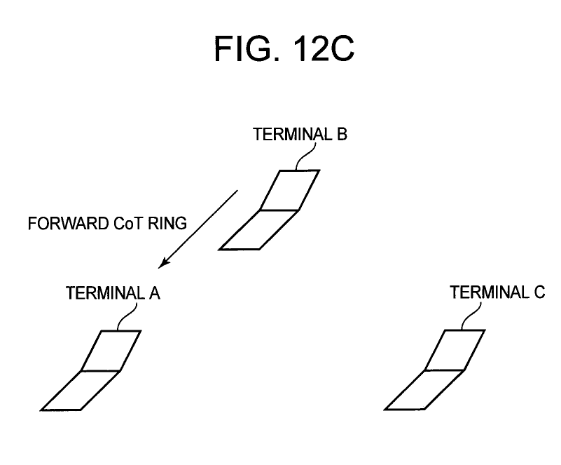

After confirming that the authentication code is correct, the terminal C forwards the HoT ring message to the terminal A as shown in FIG. 11C. Determination on forwarding from the terminal B to the terminal A in the case of the CoT ring message is also made in the same manner as shown in FIG. 12A to FIG. 12C. In order that the terminal A performs forwarding determination processing on the HoT ring message and the CoT ring message, the terminal A generates Tokens to be sent to the terminal B and the terminal C, generates Keys, generates authentication codes based on the generated Keys, and add the authentication codes to the ring messages.

As mentioned above, information for determining whether to perform forwarding is added to the HoT ring message and the CoT ring message to be sent. Data on which the authentication codes are based are also added to the HoT ring message and the CoT ring message to be sent. Data may include information such as a ring list. The ring list is data indicating the order of forwarding.

Here, the third embodiment will be described in more detail, i.e., a description will be given to illustrate how to add information on forwarding determination to the ring messages. Like in the aforementioned embodiments, it is assumed that the terminal A, the terminal B and the terminal C exist. The terminal A performs binding update to the terminal B, and the terminal B performs binding update to the terminal A as well. Similarly, the terminal A performs binding update to the terminal C, and the terminal C performs binding update to the terminal A as well. In this situation, the terminal A has to perform binding update to the terminal B and binding update to the terminal C every seven minutes in order to use the care-of address (CoA) continuously. Therefore, in order to reduce the total number of messages sent and received among the three terminals, the terminal A starts inter-group binding update processing.

The terminal A instructs the terminal B to perform binding update to the terminal C. The terminal B can refuse the instruction. If the terminal B refuses the instruction, the inter-group binding update is cancelled, and conventional MIP binding update is performed among the terminal A, the terminal B and the terminal C. If the terminal B has already performed binding update with the terminal C, the following CB-Home-Token and CB-Care-of-Token sent from the terminal C to the terminal B are sent to the terminal A.

CB-Home Token=SHA1 (B-Home Address, C's secret key, CB-home nonce)

CB-Care-of Token=SHA1 (B-Care-of Address, C's secret key, CB-care-of nonce)

If holding CB-Home Token and CB-Care-of Token, the terminal B sends the values to the terminal A. If not holding the values, the terminal B sends HoTI and CoTI to the terminal C to acquire CB-Home Token and CB-Care-of Token. In this case, no BU message may be sent. When the terminal B newly performs BU to the terminal C, the terminal B receives the HoT and CoT messages after sending the HoTI and CoTI messages, and then sends a BU message.

Upon sending CB-Home Token and CB-Care-of Token to the terminal A, the terminal B sends CB-Home Token to the Home Address of the terminal A and CB-Care-of Token to the Care-of Address of the terminal A. This is to minimize the possibility that terminals other than the terminal A will get both Tokens. The terminal B also sends nonces together with Tokens. Similarly, the terminal A instructs the terminal C to perform binding update to the terminal B. The terminal C sends the terminal A the following BC-Home Token and BC-Care-of Token:

BC-Home Token=SHA1 (C-Home Address, B's secret key, BC-home nonce)

BC-Care-of Token=SHA1 (C-Care-of Address, B's secret key, BC-care-of nonce)

The terminal A instructs the terminal B and the terminal C to send BA-Home Token, BA-Care-of Token, CA-Home Token and CA-Care-of Token addressed to the terminal A as shown below, separately from the instruction of binding update to the terminal B and the terminal C. If the terminal A holds them, the values may be used. If not holding, the terminal A sends HoTI and CoTI to the terminal B and the terminal C to acquire the Token values. In this case, the transmission of a BU message may be omitted.

BA-Home Token=SHA1 (A-Home Address, B's secret key, BA-home nonce)

BA-Care-of Token=SHA1 (A-Care-of Address, B's secret key, BA-care-of nonce)

CA-Home Token=SHA1 (A-Home Address, C's secret key, CA-home nonce)

CA-Care-of Token=SHA1 (A-Care-of Address, C's secret key, CA-care-of nonce)

Further, this may be done together with the above-mentioned instruction to the terminal B to perform binding update to the terminal C. In other words, the terminal A receives both CB-Home Token and BA-Home Token from the terminal B through one message destined to the Home Address of the terminal A. The terminal A also receives both CB-Care-of Token and BA-Care-of Token from the terminal B through one message destined to the Care-of Address of the terminal A. From the terminal C, the terminal A receives BC-Home Token, BC-Care-of Token, CA-Home Token and CA-Care-of Token. At this time, nonces are also received together with Tokens.

Further, using the home addresses and the care-of addresses of the terminal B and the terminal C, the terminal A generates the following Tokens:

AB-Home Token=SHA1 (B-Home Address, A's secret key, AB-home nonce)

AB-Care-of Token=SHA1 (B-Care-of Address, A's secret key, AB-care-of nonce)

AC-Home Token=SHA1 (C-Home Address, A's secret key, AC-home nonce)

AC-Care-of Token=SHA1 (C-Care-of Address, A's secret key, AC-care-of nonce)

Next, using the acquired Tokens, the terminal A generates the following Keys as key data:

CB-Key=SHA1 (CB-Home Token, CB-Care-of Token)

BC-Key=SHA1 (BC-Home Token, BC-Care-of Token)

BA-Key=SHA1 (BA-Home Token, BA-Care-of Token)

CA-Key=SHA1 (CA-Home Token, CA-Care-of Token)

AB-Key=SHA1 (AB-Home Token, AB-Care-of Token)

AC-Key=SHA1 (AC-Home Token, AC-Care-of Token)

Then, using the generated Keys, the terminal A generates MAC as an authentication code. The authentication code is generated from Data and Keys. The authentication code to be generated is as follows:

CB-MAC=SHA1 (CB-Key, Data)

BC-MAC=SHA1 (BC-Key, Data)

BA-MAC=SHA1 (BA-Key, Data)

CA-MAC=SHA1 (CA-Key, Data)

AB-MAC=SHA1 (AB-Key, Data)

AC-MAC=SHA1 (AC-Key, Data)

Data on which the authentication code is based may be any kind of data. For example, in the case of HoT ring, data (HoT Ring Data, CoT Ring Data) indicating the order of transmission of the HoT ring message/CoT ring message can be used. Specifically, the data is as follows:

HoT Ring Data=(B-Home Address, C-Home Address, A-Home Address)

CoT Ring Data=(C-Care-of Address, B-Care-of Address, A-Care-of Address)

The above-mentioned authentication code and nonces are added to the HoT ring message/CoT ring message to be sent, and used by a relaying terminal to determine whether to forward the message.

Next, the terminal A generates Tokens to be sent to the terminal B and the terminal C. These Tokens are called HoT Ring Token and CoT Ring Token to distinguish them from the above-mentioned Tokens. The following shows HoT Ring Tokens and CoT Ring Tokens:

AB-HoT Ring Token=SHA1 (B-Home Address, A's secret key, AB-HoT ring nonce)

AC-HoT Ring Token=SHA1 (C-Home Address, A's secret key, AC-HoT ring nonce)

AB-CoT Ring Token=SHA1 (B-Care-of Address, A's secret key, AB-CoT ring nonce)

AC-CoT Ring Token=SHA1 (C-Care-of Address, A's secret key, AC-CoT ring nonce)

Using these pieces of information, the terminal A creates the HoT ring message and the CoT ring message. HoT Ring Data and the message authentication code are added to the HoT ring message in addition to information associated with Ring Tokens, i.e., the following information is included in the HoT ring message:

B-Home Address, AB-HoT Ring Token, AB-HoT ring nonce

C-Home Address, AC-HoT Ring Token, AC-HoT ring nonce

HoT Ring Data

BC-MAC, BC-home nonce, BC-care-of nonce, C-Care-of Address

CA-MAC, CA-home nonce, CA-care-of nonce, A-Care-of Address

AB-MAC, AB-home nonce, AB-care-of nonce, B-Care-of Address

Similarly, CoT Ring Data and the message authentication code are added to the CoT ring message in addition to information associated with Ring Tokens, i.e., the following information is included in the CoT ring message:

C-Care-of Address, AC-CoT Ring Token, AC-CoT ring nonce

B-Care-of Address, AB-CoT Ring Token, AB-CoT ring nonce

CoT Ring Data

CB-MAC, CB-home nonce, CB-care-of nonce, B-Home Address

BA-MAC, BA-home nonce, BA-care-of nonce, A-Home Address

AC-MAC, AC-home nonce, AC-care-of nonce, C-Home Address

The terminal A sends the HoT ring message to the Home Address of the terminal B. The terminal A also sends the CoT ring message to the Care-of Address of the terminal C.

Next, HoT ring processing at the terminal B will be described. When receiving the HoT ring message, the terminal B holds Ring Token addressed to the terminal B as shown below. Before starting the HoT ring processing, the terminal B may check whether any binding cache exists between the terminal B and the terminal A.

B-Home Address, AB-HoT Ring Token, AB-HoT ring nonce

The terminal B checks the authentication code to determine whether to forward the HoT ring message to the terminal C. First, the terminal B uses C-Home Address, C-Care-of Address, BC-home nonce and BC-care-of nonce to generate the following Home Token and Care-of Token:

BC-Home Token=SHA1 (C-Home Address, B's secret key, BC-home nonce)

BC-Care-of Token=SHA1 (C-Care-of Address, B's secret key, BC-care-of nonce)

Further, from these Tokens, the terminal B generates the following Key:

BC-Key=SHA1 (BC-Home Token, BC-Care-of Token)

Then, using the generated HoT Ring Data to be the basis of the Key and the authentication code, the terminal B generates the following authentication code, and compares it with the authentication code with that added to the HoT ring message:

BC-MAC=SHA1 (BC-Key, HoT Ring Data)

If the authentication code is correct, the terminal B generates the following HoT Ring Tokens:

BC-HoT Ring Token=SHA1 (C-Home Address, B's secret key, BC-HoT ring nonce)

BA-HoT Ring Token=SHA1 (A-Home Address, B's secret key, BA-HoT ring nonce)

Then, the terminal B adds the following information to the HoT ring message:

C-Home Address, BC-HoT Ring Token, BC-HoT ring nonce

A-Home Address, BA-HoT Ring Token, BA-HoT ring nonce

Information included in the HoT ring message to be sent from the terminal B to the terminal C in the above processing is the following information:

C-Home Address, AC-HoT Ring Token, AC-HoT ring nonce (information from the terminal A)

C-Home Address, BC-HoT Ring Token, BC-HoT ring nonce (added by the terminal B)

A-Home Address, BA-HoT Ring Token, BA-HoT ring nonce (added by the terminal B)

HoT Ring Data

CA-MAC, CA-home nonce, CA-care-of nonce, A-Care-of Address (information from the terminal A)

AB-MAC, AB-home nonce, AB-care-of nonce, B-Care-of Address (information from the terminal A)

Next, HoT ring processing at the terminal C will be described. When receiving the HoT ring message, the terminal C holds Ring Tokens addressed to the terminal C, i.e., the following information:

C-Home Address, AC-HoT Ring Token, AC-HoT ring nonce

C-Home Address, BC-HoT Ring Token, BC-HoT ring nonce

The terminal C checks the authentication code to determine whether to forward the HoT ring message to the terminal A. First, the terminal C uses A-Home Address, A-Care-of Address, CA-home nonce and CA-care-of nonce to generate the following Home Token and Care-of Token:

CA-Home Token=SHA1 (A-Home Address, C's secret key, CA-home nonce)

CA-Care-of Token=SHA1 (A-Care-of Address, C's secret key, CA-care-of nonce)

Further, the terminal C generates Key from these Tokens.

CA-Key=SHA1 (CA-Home Token, CA-Care-of Token)

Then, using the generated Key and HoT Ring Data on which the authentication code is based, the terminal C generates the following authentication code MAC and compares it with the authentication code added to the HoT ring message:

CA-MAC=SHA1 (CA-Key, HoT Ring Data)

If the authentication code is correct, the terminal C generates the following HoT Ring Tokens:

CA-HoT Ring Token=SHA1 (A-Home Address, C's secret key, CA-HoT ring nonce)

CB-HoT Ring Token=SHA1 (B-Home Address, C's secret key, CB-HoT ring nonce)

Then, the terminal C adds the following information to the HoT ring message:

A-Home Address, CA-HoT Ring Token, CA-HoT ring nonce

B-Home Address, CB-HoT Ring Token, CB-HoT ring nonce

Information included in the HoT ring message to be sent from the terminal C to the terminal A in the above processing is the following information:

A-Home Address, BA-HoT Ring Token, BA-HoT ring nonce (information from the terminal B)

A-Home Address, CA-HoT Ring Token, CA-HoT ring nonce (added by the terminal C)

B-Home Address, CB-HoT Ring Token, CB-HoT ring nonce (added by the terminal C)

HoT Ring Data

AB-MAC, AB-home nonce, AB-care-of nonce, B-Care-of Address (information from the terminal A)

Next, HoT ring processing at the terminal A will be described. When receiving the HoT ring message, the terminal A holds Ring Tokens addressed to the terminal A, i.e., the following information:

A-Home Address, BA-HoT Ring Token, BA-HoT ring nonce

A-Home Address, CA-HoT Ring Token, CA-HoT ring nonce

The terminal A checks the authentication code to determine whether to forward the HoT ring message to the terminal B. First, the terminal A uses B-Home Address, B-Care-of Address, AB-home nonce and AB-care-of nonce to generate the following Home Token and Care-of Token:

AB-Home Token=SHA1 (B-Home Address, A's secret key, AB-home nonce)

AB-Care-of Token=SHA1 (B-Care-of Address, A's secret key, AB-care-of nonce)

Further, the terminal A generates the following Key from these Tokens:

AB-Key=SHA1 (AB-Home Token, AB-Care-of Token)

Then, using the generated Key and HoT Ring Data on which the authentication code is based, the terminal A generates the following authentication code MAC and compares it with the authentication code added to the HoT ring message:

AB-MAC=SHA1 (CA-Key, Data)

Information included in the HoT ring message to be sent from the terminal the terminal A to the terminal B in the above processing is the following information:

B-Home Address, CB-HoT Ring Token, CB-HoT ring nonce (added by the terminal C)

Next, CoT ring processing at the terminal C will be described. The HoT ring processing is almost the same processing as well. When receiving the CoT ring message, the terminal C holds Ring Token addressed to the terminal C. In other words, the terminal C holds the following information:

C-Care-of Address, AC-CoT Ring Token, AC-CoT ring nonce

The terminal C checks the authentication code to determine whether to forward the CoT ring message to the terminal B. First, the terminal C generates the following Home Token and Care-of Token using B-Care-of Address, B-Home Address, CB-home nonce and CB-care-of nonce:

CB-Home Token=SHA1 (B-Home Address, C's secret key, CB-home nonce)

CB-Care-of Token=SHA1 (B-Care-of Address, C's secret key, CB-care-of nonce)

Further, the terminal C generates the following Key from these Tokens:

CB-Key=SHA1 (CB-Home Token, CB-Care-of Token)

Then, using the generated Key and CoT Ring Data on which the authentication code is based, the terminal C generates the following authentication code MAC and compares it with the authentication code added to the CoT ring message:

CB-MAC=SHA1 (CB-Key, CoT Ring Data)

If the authentication code is correct, the terminal C generates the following CoT Ring Tokens:

CB-CoT Ring Token=SHA1 (B-Care-of Address, C's secret key, CB-CoT ring nonce)

CA-CoT Ring Token=SHA1 (A-Care-of Address, C's secret key, CA-CoT ring nonce)

Then, the terminal C adds the following information to the CoT ring message:

B-Care-of Address, CB-CoT Ring Token, CB-CoT ring nonce

A-Care-of Address, CA-CoT Ring Token, CA-CoT ring nonce

Information included in the CoT ring message to be sent from the terminal B to the terminal C in the above processing is the following information:

B-Care-of Address, AB-CoT Ring Token, AB-CoT ring nonce (information from the terminal A)

B-Care-of Address, CB-CoT Ring Token, CB-CoT ring nonce (added by the terminal C)

A-Care-of Address, CA-CoT Ring Token, CA-CoT ring nonce (added by the terminal C)

CoT Ring Data

BA-MAC, BA-home nonce, BA-care-of nonce, A-Home Address (information from the terminal A)

AC-MAC, AC-home nonce, AC-care-of nonce, C-Home Address (information from the terminal A)

Next, CoT ring processing at the terminal B will be described. When receiving the CoT ring message, the terminal B holds Ring Tokens addressed to the terminal B. In other words, the terminal B holds the following information:

B-Care-of Address, AB-CoT Ring Token, AB-CoT ring nonce

B-Care-of Address, CB-CoT Ring Token, CB-CoT ring nonce

The terminal B checks the authentication code to determine whether to forward the CoT ring message to the terminal A. First, the terminal B generates the following Home Token and Care-of Token using A-Home Address, A-Care-of Address, BA-home nonce and BA-care-of nonce:

BA-Home Token=SHA1 (A-Home Address, B's secret key, BA-home nonce)

BA-Care-of Token=SHA1 (A-Care-of Address, B's secret key, BA-care-of nonce)

Further, the terminal B generates Key from these Tokens.

BA-Key=SHA1 (BA-Home Token, BA-Care-of Token)

Then, using the generated Key and CoT Ring Data on which the authentication code is based, the terminal B generates the following authentication code MAC and compares it with the authentication code added to the CoT ring message:

BA-MAC=SHA1 (BA-Key, CoT Ring Data)

If the authentication code is correct, the terminal B generates the following CoT Ring Tokens:

BC-CoT Ring Token=SHA1 (C-Care-of Address, B's secret key, BC-CoT ring nonce)

BA-CoT Ring Token=SHA1 (A-Care-of Address, B's secret key, BA-CoT ring nonce)

Then, the terminal B adds the following information to the HoT ring message:

A-Care-of Address, BA-CoT Ring Token, BA-CoT ring nonce

C-Care-of Address, BC-CoT Ring Token, BC-CoT ring nonce

Information included in the CoT ring message to be sent from the terminal B to the terminal A in the above processing is the following information:

A-Care-of Address, CA-CoT Ring Token, CA-CoT ring nonce (information from the terminal C)

A-Care-of Address, BA-CoT Ring Token, BA-CoT ring nonce (added by the terminal B)

C-Care-of Address, BC-CoT Ring Token, BC-CoT ring nonce (added by the terminal B)

CoT Ring Data

AC-MAC, AC-home nonce, AC-care-of nonce, C-Home Address (information from the terminal A)

Next, CoT ring processing at the terminal A will be described. When receiving the CoT ring message, the terminal A holds Ring Tokens addressed to the terminal A. In other words, the terminal A holds the following information:

A-Care-of Address, CA-CoT Ring Token, CA-CoT ring nonce

A-Care-of Address, BA-CoT Ring Token, BA-CoT ring nonce

The terminal A checks the authentication code to determine whether to forward the CoT ring message to the terminal C. First, the terminal A generates the following Home Token and Care-of Token using C-Home Address, C-Care-of Address, AC-home nonce and AC-care-of nonce:

AC-Home Token=SHA1 (C-Home Address, A's secret key, AC-home nonce)

AC-Care-of Token=SHA1 (C-Care-of Address, A's secret key, AC-care-of nonce)

Further, the terminal A generates Key from these Tokens.

AC-Key=SHA1 (AC-Home Token, AC-Care-of Token)

Then, using the generated Key and CoT Ring Data on which the authentication code is based, the terminal A generates the following authentication code MAC and compares it with the authentication code added to the CoT ring message:

AC-MAC=SHA1 (AC-Key, CoT Ring Data)

Information included in the CoT ring message to be sent from the terminal A to the terminal C in the above processing is the following information:

C-Care-of Address, BC-CoT Ring Token, BC-CoT ring nonce (information from the terminal B)

Next, the operation of terminals when receiving both the HoT ring message and the CoT ring message will be described. The terminal B acquires the following information from the HoT ring message:

B-Home Address, AB-HoT Ring Token, AB-HoT ring nonce

B-Home Address, CB-HoT Ring Token, CB-HoT ring nonce

The terminal B also acquires the following information from the CoT ring message:

B-Care-of Address, AB-CoT Ring Token, AB-CoT ring nonce

B-Care-of Address, CB-CoT Ring Token, CB-CoT ring nonce

Using these Tokens, the terminal B generates Keys.

AB-Key=SHA1 (AB-HoT Ring Token, AB-CoT Ring Token)

CB-Key=SHA1 (CB-HoT Ring Token, CB-CoT Ring Token)

Then, using these Keys, the terminal B generates an authentication code, and sends the terminal A a BU message to which AB-HoT ring nonce and AB-CoT ring nonce are added together with the generated authentication code and the like. Further, the terminal B sends the terminal C a BU message to which CB-HoT ring nonce and CB-CoT ring nonce are added together with the generated authentication code and the like.

On the other hand, the terminal C acquires the following information from the HoT ring message:

C-Home Address, AC-HoT Ring Token, AC-HoT ring nonce

C-Home Address, BC-HoT Ring Token, BC-HoT ring nonce

The terminal C also acquires the following information from the CoT ring message:

C-Care-of Address, AC-CoT Ring Token, AC-CoT ring nonce

C-Care-of Address, BC-CoT Ring Token, BC-CoT ring nonce

Using these Tokens, the terminal C generates Keys.

AC-Key=SHA1 (AC-HoT Ring Token, AC-CoT Ring Token)

BC-Key=SHA1 (BC-HoT Ring Token, BC-CoT Ring Token)

Then, using these Keys, the terminal C generates an authentication code, and sends the terminal A a BU message to which AC-HoT ring nonce and AC-CoT ring nonce are added together with the generated authentication code and the like. Further, the terminal C sends the terminal B a BU message to which BC-HoT ring nonce and BC-CoT ring nonce are added together with the generated authentication code and the like.

On the other hand, the terminal A acquires the following information from the HoT ring message:

A-Home Address, BA-HoT Ring Token, BA-HoT ring nonce

A-Home Address, CA-HoT Ring Token, CA-HoT ring nonce

The terminal A also acquires the following information from the CoT ring message:

A-Care-of Address, CA-CoT Ring Token, CA-CoT ring nonce

A-Care-of Address, BA-CoT Ring Token, BA-CoT ring nonce

Using these Tokens, the terminal A generates Keys.

BA-Key=SHA1 (BA-HoT Ring Token, BA-CoT Ring Token)

CA-Key=SHA1 (CA-HoT Ring Token, CA-CoT Ring Token)

Then, using these Keys, the terminal A generates an authentication code, and sends the terminal B a BU message to which BA-HoT ring nonce and BA-CoT ring nonce are added together with the generated authentication code and the like. Further, the terminal A sends the terminal A a BU message to which CA-HoT ring nonce and CA-CoT ring nonce are added together with the generated authentication code and the like.

The same processing can be performed even in a case where the number of the terminals is four or more. For example, when the number of the terminals is four, the terminal A instructs terminal D to perform binding update to the terminal B and the terminal C. The terminal A also instructs the terminal B and the terminal C to perform binding update to the terminal D. Then, the terminal A collects Tokens. The terminal A generates a ring list, generates Tokens to be sent to each terminal, generates a message authentication code, and sends a HoT ring message and a CoT ring message to which these pieces of information are added.

Next, a mobile terminal on the side of initiating the above-mentioned ring binding update will be described. Note that the configuration of the mobile terminal is the same as that shown in FIG. 2 mentioned above. Therefore, the description will be given with reference to FIG. 2. Here, the terminal A is taken as an example to describe a case where the terminal A performs ring binding update to the terminal B and the terminal C. First, the terminal A creates, in the message creation unit 203, a message to request the terminal B and the terminal C to perform BU to each other, and sends the message from the message transmitting unit 204. A response message to the message sent is received at the message receiving unit 206, and Tokens included in the response message are stored in the Token storage unit 213 for forwarding determination.

Upon generating a message authentication code for forwarding determination using the collected Tokens, the terminal A first acquires Tokens from the Token storage unit for forwarding determination 213, and generates key data in the Key generation unit 208. Then, the message authentication code generating unit 209 acquires Ring Data from the Ring Data creation unit 205, and generates a message authentication code using the key data generated by the Key generation unit 208. Further, Ring Tokens are generated in the Token generation unit 201. Nonces used for Token generation are managed and stored in the Nonce management unit 202. The message creation unit 203 creates a HoT ring message/CoT ring message to which the message authentication code for forwarding determination, Ring Data and Ring Tokens are added. The HoT ring message/CoT ring message is sent from the message transmitting unit 204.

Next, processing after receiving the HoT ring message and the CoT ring message passed back will be described. When the ring message is received at the message receiving unit 206, Ring Tokens addressed to its own terminal are stored in the Ring Token storage unit 207. If any forwarding destination remains, Tokens are generated in the Token generation unit 201, key data is generated in the Key generation unit 208, and a message authentication code is generated in the message authentication code generating unit 209 using the Ring Data added to the message. In the message authentication code comparing unit 210, the generated message authentication code is compared with a message authentication code added to the message, and in the forwarding of ring message determining unit 212, it is determined whether to perform forwarding.

When both Tokens, Home Token and Care-of Token, are gathered in the Ring Token storage unit 207, key data is generated in the Key generation unit 208, and a message authentication code is generated based on message data in the message authentication code generating unit 209. The generated message authentication code is added to the BU message in the message creation unit 203, and sent from the message transmitting unit 204.

Since the following is the same as normal MIP binding update processing, a brief description will be given. When receiving a HoTI/CoTI message at the message receiving unit 206, Tokens are generated in the Token generation unit 201, a response message is created in the message creation unit 203, and the created message is sent from the message transmitting unit 204. Nonces used upon Token generation are stored and managed in the Nonce management unit 202.

Further, when receiving a BU message, Home Token and Care-of Token are generated in the Token generation unit 201 using addresses and Nonce-IDs included. Using the generated Tokens, key data is generated in the Key generation unit 208, and using the key data and the message data, a message authentication code is generated in the message authentication code generating unit 209. Then, in the message authentication code comparing unit 210, the generated message authentication code is compared with a message authentication code added to the BU message, and if they match, a binding cache is registered in the binding cache management unit 211.

Next, a mobile terminal on the side of participating in ring binding update will be described. Since the configuration of the mobile terminal is the same as that shown in FIG. 3, the description will be given with reference to FIG. 3. Further, the terminal B is taken as an example here. In other words, the description is given of the terminal B when the terminal A performs ring binding update to the terminal B and the terminal C.

First, in response to a request from the terminal A, the terminal B sends HoTI/CoTI to the terminal C, and receives HoT/CoT. Then, Tokens included in the HoT/CoT are sent to HoA and CoA of the terminal A, respectively. In this processing, the terminal B receives, at the message receiving unit 307, the request from the terminal A, creates HoTI/CoTI in the message creation unit 302, and sends it from the message transmitting unit 304.

When receiving HoT/CoT, the terminal B generates key data for the terminal C in the Key generation unit 305, generates a message authentication code in the message authentication code generating unit 306, adds the generated message authentication code to a BU message, and sends the BU message. On the other hand, for the terminal A, a message with which Tokens addressed to HoA and CoA are sent is created in the message creation unit 302, and sent from the message transmitting unit 304.

After that, when receiving the HoT ring message or CoT ring message from the terminal A, the terminal B first checks the message authentication code for forwarding determination. To this end, Tokens are generated using Nonces acquired from the Nonce management unit 308 using the addresses of the forwarding destination terminal and Nonce-IDs included in the message. Using the generated Home Token and Care-of Token, key data is generated in the Key generation unit 305.

Then, using the generated key data and Ring Data added to the message, a message authentication code is generated in the message authentication code generating unit 306, and in the message authentication code comparing unit 309, the generated message authentication code is compared with a message authentication code added to the ring message. In response to the result indicating that the message authentication codes match, the forwarding of ring message determining unit 311 decides to perform forwarding.

Ring Tokens included in the ring message and addressed to its own terminal are stored in the Ring Token storage unit 301. The message creation unit 301 adds, to the ring message to be forwarded, Ring Tokens generated in the Token generation unit 303 to be addressed to the forwarding destination terminal. Then, the ring message is sent from the message transmitting unit 304.

After the terminal B receives the ring message, when both HoT Ring Token and CoT Ring Token are gathered, key data is generated in the Key generation unit 305 to create a BU message, a message authentication code is generated in the message authentication code generating unit 306, the generated message authentication code is added to the BU message in the message creation unit 302, and the BU message is sent from the message transmitting unit 304.

Since the following is the same as normal MIP binding update processing, a brief description will be given. When receiving a HoTI/CoTI message at the message receiving unit 307, Tokens are generated in the Token generation unit 303, a response message is created in the message creation unit 302, and the created message is sent from the message transmitting unit 304. Nonces used upon Token generation are stored and managed in the Nonce management unit 308.

Further, when the terminal B receives the BU message, Home Token and Care-of Token are generated in the Token generation unit 303 using addresses and Nonce-IDs included. Using the generated Tokens, key data is generated in the Key generation unit 305, and using the key data and message data, a message authentication code is generated in the message authentication code generating unit 306. In the message authentication code comparing unit 309, the generated message authentication code is compared with a message authentication code added to the BU message, and if they match, a binding cache is registered in the binding cache management unit 310.

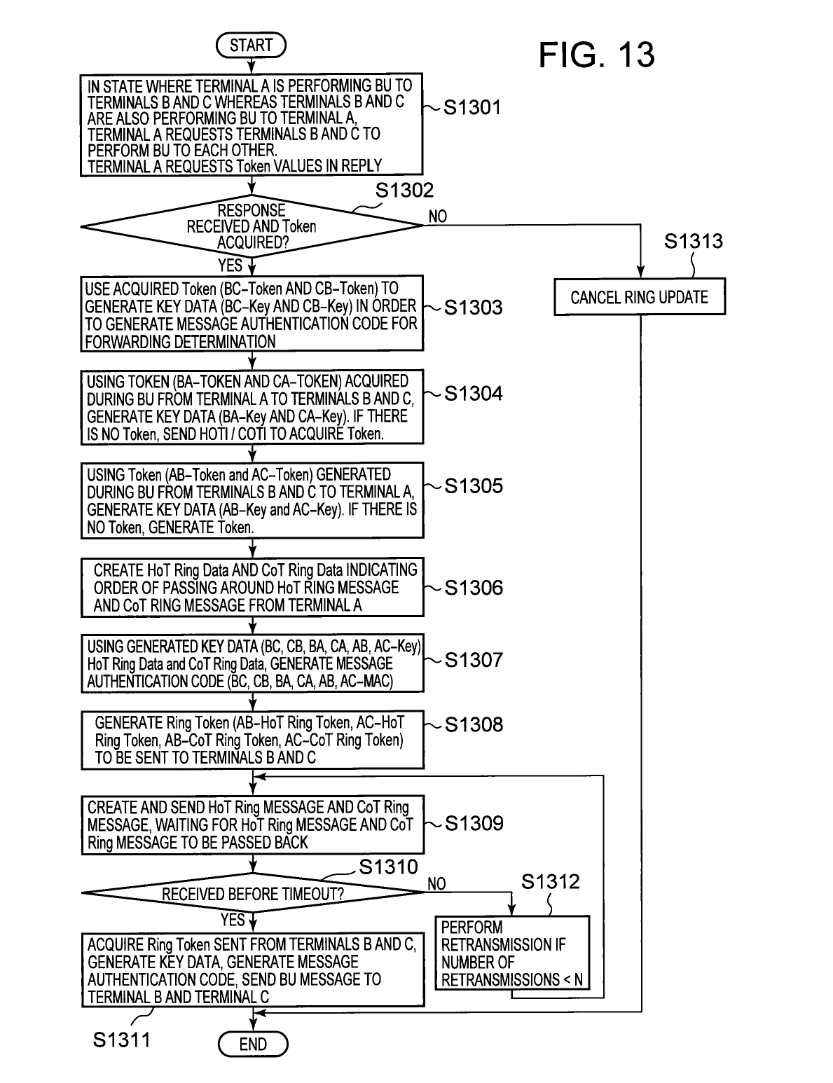

Referring next to FIG. 13, a processing flow in a mobile terminal on the side of initiating ring binding update will be described. As shown in FIG. 13, in a state where the terminal A is performing BU to the terminal B and the terminal C whereas the terminal B and the terminal C are also performing BU to the terminal A, the terminal A requests the terminal B and the terminal C to perform BU to each other, requesting Token values in reply (step S1301). The terminal A determines whether a response is received and Tokens are acquired (step S1302). If a response is received and Tokens are acquired, the terminal A uses the acquired Tokens (BC-Token and CB-Token) to generate key data (BC-Key and CB-Key) in order to generate a message authentication code for forwarding determination (step S1303).

Then, using Tokens (BA-Token and CA-Token) acquired during BU from the terminal A to the terminals B and C, the terminal A generates key data (BA-Key and CA-Key) (step S1304). If there is no Token (BA-Token or CA-Token), HoTI/CoTI is sent to acquire the Token. Using Tokens (AB-Token and AC-Token) generated upon BU from the terminals B and C to the terminal A, the terminal A generates key data (AB-Key and AC-Key) (step S1305). If there is no Token (AB-Token or AC-Token), the Token is generated.

The terminal A creates HoT Ring Data and CoT Ring Data indicating the order of passing around the HoT ring message and CoT ring message from the terminal A (step S1306). Using the generated key data (BC-Key, CB-Key, BA-Key, CA-Key, AB-Key, AC-Key), HoT Ring Data and CoT Ring Data, the terminal A generates a message authentication code (BC-MAC, CB-MAC, BA-MAC, CA-MAC, AB-MAC, AC-MAC) (step S1307). The terminal A also generates Ring Tokens (AB-HoT Ring Token, AC-HoT Ring Token, AB-CoT Ring Token, AC-CoT Ring Token) to be sent to the terminal B and the terminal C (step S1308).

The terminal A creates and sends the HoT Ring message and the CoT Ring message, waiting for the HoT Ring message and CoT Ring message to be passed back (step S1309). The terminal A determines whether the messages have been received before a predetermined timeout (step S1310). If the messages have been received, the terminal A acquires Ring Tokens sent from the terminals B and C, generates key data, generates a message authentication code, and sends a BU message to the terminals B and C (step S1311). In step S1310, if no message has been received, the terminal A performs retransmission on condition that the number of retransmissions is smaller than a predetermined value N (step S1312). Further, in step S1302, if no response is received and no Tokens are acquired, the terminal A cancels the ring update (step S1313).

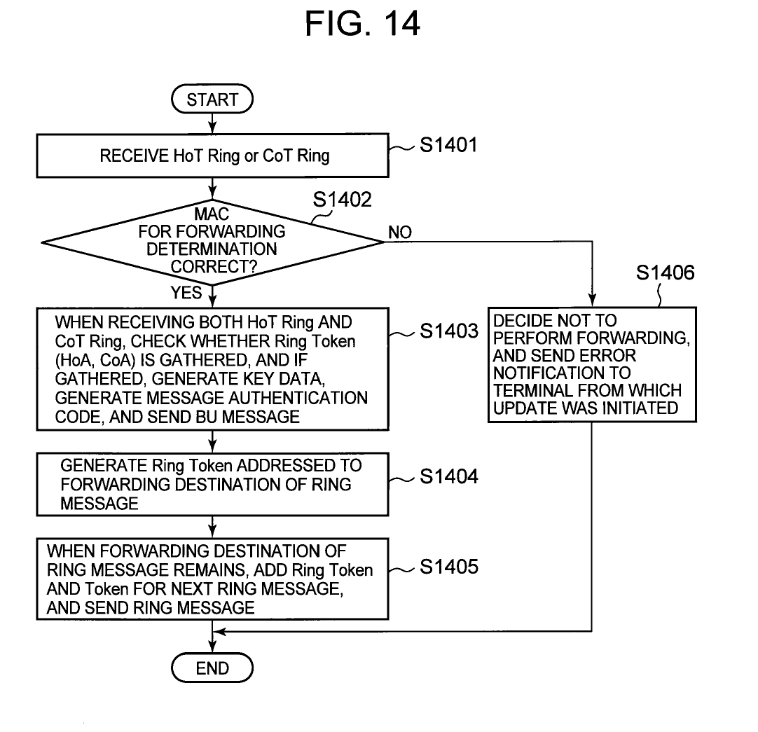

Referring next to FIG. 14, a processing flow in a mobile terminal on the side of participating in ring binding update will be described. As shown in FIG. 14, the terminal B receives a HoT ring message or CoT ring message, for example (step S1401). The terminal B determines whether MAC for forwarding determination is correct (step S1402). When MAC is correct and when the terminal B receives both the HoT ring message and the CoT ring message, the terminal B checks whether Ring Tokens (HoA, CoA) are gathered. If gathered, the terminal B generates key data, generates a message authentication code, and sends a BU message (step S1403).

The terminal B generates Ring Tokens addressed to the forwarding destination of the ring message (step S1404). If any forwarding destination of the ring message remains, the terminal B adds Ring Tokens for the forwarding destination terminal to the ring message, and forwards the ring message (step S1405). In step S1402, if MAC for forwarding determination is not correct, the terminal B decides not to perform forwarding. In this case, an error notification may be sent to a terminal from which the ring binding update was initiated (step S1406).

### Fourth Embodiment

A fourth embodiment will be described. Here, a method of sending HoT ring message and CoT ring message continuously will be described. As mentioned above, processing for collecting Tokens beforehand is necessary to add information for determining whether to perform forwarding to the HoT ring message and the CoT ring message. If Tokens are collected each time a HoT ring message or CoT ring message is sent, the advantage of reducing the number of messages will be reduced. Therefore, Tokens for the next forwarding determination processing are also collected through the HoT ring message/CoT ring message.

A HoT ring message sent by the terminal A flows around as follows: terminal A→terminal B→terminal C→terminal A→terminal B. In this flow, the terminal B adds Home Token for the terminal C and Home Token for the terminal A to the HoT ring message, and sends the HoT ring message. The terminal C adds Home Token for the terminal A and Home Token for the terminal B to the HoT ring message, and sends the HoT ring message. These Tokens are collected by the terminal A and used for generation of an authentication code for forwarding determination of the next HoT ring message.

BC-Home Token=SHA1 (C-HoA, B's secret key, nonce)

BA-Home Token=SHA1 (A-HoA, B's secret key, nonce)

CA-Home Token=SHA1 (A-HoA, C's secret key, nonce)

CB-Home Token=SHA1 (B-HoA, C's secret key, nonce)

On the other hand, in the case of a CoT ring message, it flows around as follows: terminal A→terminal C→terminal B→terminal A→terminal C. The terminal C adds, to CoT, Care-of Token for the terminal B and Care-of Token for the terminal A, and the terminal B adds, to CoT, Care-of Token for the terminal C and Care-of Token for the terminal A. The terminal A collects these Tokens.

CB-Care-of Token=SHA1 (B-CoA, C's secret key, nonce)

CA-Care-of Token=SHA1 (A-CoA, C's secret key, nonce)

BC-Care-of Token=SHA1 (C-CoA, B's secret key, nonce)

BA-Care-of Token=SHA1 (A-CoA, B's secret key, nonce)

In this case, since the HoT ring message and the CoT ring message also flow in opposite directions, only the terminal A can collect both Home Token and Care-of Token. Thus, only the terminal A can initiate transmission of the HoT ring message and the CoT ring message. This is because the terminal A is the terminal that has first collected Tokens for initiating the transmission of the HoT ring message and the CoT ring message. In other words, the terminal B and the terminal C determine that they can provide Tokens to the terminal A. Thus, Tokens for the next HoT ring message/CoT ring message are collected through the HoT ring message/CoT ring message, and this enable reduction in the number of messages.

Here, the fourth embodiment will be described in more detail, i.e., a description will be given to illustrate a case where forwarding determination information for the next ring message is added to the ring message. Like in the aforementioned embodiments, it is assumed that terminal A, terminal B and terminal C exist. The terminal A performs binding update to the terminal B, and the terminal B performs binding update to the terminal A as well. Similarly, the terminal A performs binding update to the terminal C, and the terminal C performs binding update to the terminal A as well. In this situation, the terminal A has to perform binding update to the terminal B and the terminal C every seven minutes in order to use the care-of address (CoA) continuously. Therefore, in order to reduce the total number of messages sent and received among the three terminals, the terminal A starts inter-group binding update processing.

The terminal A instructs the terminal B to perform binding update to the terminal C. The terminal B can refuse this instruction. If refused, the inter-group binding update is cancelled, and conventional MIP binding update is performed among the terminal A, the terminal B and the terminal C. If the terminal B has already performed binding update with the terminal C, the following CB-Home-Token and CB-Care-of-Token sent from the terminal C to the terminal B are sent to the terminal A.

CB-Home Token=SHA1 (B-Home Address, C's secret key, CB-home nonce)

CB-Care-of Token=SHA1 (B-Care-of Address, C's secret key, CB-care-of nonce)

If holding CB-Home Token and CB-Care-of Token, the terminal B sends the values to the terminal A. If not holding the values, the terminal B sends HoTI and CoTI to the terminal C to acquire CB-Home Token and CB-Care-of Token. In this case, no BU message may be sent. When the terminal B newly performs BU to the terminal C, the terminal B receives HoT and CoT after sending HoTI and CoTI, and then sends a BU message.

Upon sending CB-Home Token and CB-Care-of Token to the terminal A, the terminal B sends CB-Home Token to the Home Address of the terminal A and CB-Care-of Token to the Care-of Address of the terminal A. This is to minimize the possibility that terminals other than the terminal A will get both Tokens. The terminal B also sends nonces together with Tokens. Similarly, the terminal A instructs the terminal C to perform binding update to the terminal B. The terminal C sends the terminal A the following BC-Home Token and BC-Care-of Token:

BC-Home Token=SHA1 (C-Home Address, B's secret key, BC-home nonce)

BC-Care-of Token=SHA1 (C-Care-of Address, B's secret key, BC-care-of nonce)

The terminal A instructs the terminal B and the terminal C to send BA-Home Token, BA-Care-of Token, CA-Home Token and CA-Care-of Token addressed to the terminal A as shown below, separately from the instruction of binding update to the terminal B and the terminal C. If the terminal A holds them, the values may be used. If not holding, the terminal A sends HoTI and CoTI to the terminal B and the terminal C to acquire the Token values. In this case, the transmission of a BU message may be omitted.

BA-Home Token=SHA1 (A-Home Address, B's secret key, BA-home nonce)

BA-Care-of Token=SHA1 (A-Care-of Address, B's secret key, BA-care-of nonce)

CA-Home Token=SHA1 (A-Home Address, C's secret key, CA-home nonce)

CA-Care-of Token=SHA1 (A-Care-of Address, C's secret key, CA-care-of nonce)

Further, this may be done together with the above-mentioned instruction to the terminal B to perform binding update to the terminal C. In other words, the terminal A receives both CB-Home Token and BA-Home Token from the terminal B through one message destined to the Home Address of the terminal A. The terminal A also receives both CB-Care-of Token and BA-Care-of Token from the terminal B through one message destined to the Care-of Address of the terminal A. From the terminal C, the terminal A receives BC-Home Token, BC-Care-of Token, CA-Home Token and CA-Care-of Token. At this time, nonces are also received together with Tokens.

Further, using the home addresses and the care-of addresses of the terminal B and the terminal C, the terminal A generates the following Token:

AB-Home Token=SHA1 (B-Home Address, A's secret key, AB-home nonce)

AB-Care-of Token=SHA1 (B-Care-of Address, A's secret key, AB-care-of nonce)

AC-Home Token=SHA1 (C-Home Address, A's secret key, AC-home nonce)

AC-Care-of Token=SHA1 (C-Care-of Address, A's secret key, AC-care-of nonce)

In the above, the method of requesting binding update as a method of causing the terminal A to collect Tokens from the terminal B and the terminal C has been described. However, if Tokens are already collected, new binding update does not need requesting. For example, this is a case where the HoT ring message and the CoT ring message have already been sent and Tokens have already been collected.

Using the acquired Tokens, the terminal A generates the following Keys:

CB-Key=SHA1 (CB-Home Token, CB-Care-of Token)

BC-Key=SHA1 (BC-Home Token, BC-Care-of Token)

BA-Key=SHA1 (BA-Home Token, BA-Care-of Token)

CA-Key=SHA1 (CA-Home Token, CA-Care-of Token)

AB-Key=SHA1 (AB-Home Token, AB-Care-of Token)

AC-Key=SHA1 (AC-Home Token, AC-Care-of Token)

Then, using the generated Keys, the terminal A generates an authentication code MAC. The authentication code is generated from Data and Keys. The authentication code to be generated is as follows:

CB-MAC=SHA1 (CB-Key, Data)

BC-MAC=SHA1 (BC-Key, Data)

BA-MAC=SHA1 (BA-Key, Data)

CA-MAC=SHA1 (CA-Key, Data)

AB-MAC=SHA1 (AB-Key, Data)

AC-MAC=SHA1 (AC-Key, Data)

Data on which the authentication code is based may be any kind of data. For example, in the case of HoT ring, data (HoT Ring Data and CoT Ring Data to be shown below) indicating the order of transmission of the HoT ring message/CoT ring message can be used.

HoT Ring Data=(B-Home Address, C-Home Address, A-Home Address)

CoT Data=(C-Care-of Address, B-Care-of Address, A-Care-of Address)

The above-mentioned authentication code and nonces are added to the HoT ring message/CoT ring message to be sent, and used by a relaying terminal to determine whether to forward the message.

Next, the terminal A generates Tokens to be sent to the terminal B and the terminal C. These Tokens are called HoT Ring Token and CoT Ring Token to distinguish them from the above-mentioned Tokens. The following shows HoT Ring Token and CoT Ring Token, and using these pieces of information, the terminal A creates a HoT ring message/CoT ring message:

AB-HoT Ring Token=SHA1 (B-Home Address, A's secret key, AB-HoT ring nonce)

AC-HoT Ring Token=SHA1 (C-Home Address, A's secret key, AC-HoT ring nonce)

AB-CoT Ring Token=SHA1 (B-Care-of Address, A's secret key, AB-CoT ring nonce)

AC-CoT Ring Token=SHA1 (C-Care-of Address, A's secret key, AC-CoT ring nonce)

In addition to the information associated with Ring Tokens, the HoT Ring Data and the message authentication code are added to the HoT ring message. In other words, the HoT ring message includes the following information:

B-Home Address, AB-HoT Ring Token, AB-HoT ring nonce

C-Home Address, AC-HoT Ring Token, AC-HoT ring nonce

HoT Ring Data

BC-MAC, BC-home nonce, BC-care-of nonce, C-Care-of Address

CA-MAC, CA-home nonce, CA-care-of nonce, A-Care-of Address

AB-MAC, AB-home nonce, AB-care-of nonce, B-Care-of Address

Similarly, CoT Ring Data and the message authentication code are added to the CoT ring message in addition to the information associated with Ring Tokens. In other words, the CoT ring message includes the following information:

C-Care-of Address, AC-CoT Ring Token, AC-CoT ring nonce

B-Care-of Address, AB-CoT Ring Token, AB-CoT ring nonce

CoT Ring Data

CB-MAC, CB-home nonce, CB-care-of nonce, B-Home Address

BA-MAC, BA-home nonce, BA-care-of nonce, A-Home Address

AC-MAC, AC-home nonce, AC-care-of nonce, C-Home Address

The terminal A sends the HoT ring message to Home Address of the terminal B. The terminal A also sends the CoT ring message to Care-of Address of the terminal C.

Next, HoT ring processing at the terminal B will be described. When receiving the HoT ring message, the terminal B holds Ring Tokens addressed to the terminal B. Before starting the HoT ring processing, the terminal B may check the presence of a binding cache between the terminal B and the terminal A.

B-Home Address, AB-HoT Ring Token, AB-HoT ring nonce

The terminal B checks the authentication code to determine whether the HoT ring message should be forwarded to the terminal C. First, the following Home Token and Care-of Token are generated using C-Home Address, C-Care-of Address, BC-home nonce and BC-care-of nonce:

BC-Home Token=SHA1 (C-Home Address, B's secret key, BC-home nonce)

BC-Care-of Token=SHA1 (C-Care-of Address, B's secret key, BC-care-of nonce)

Further, the terminal B generates Key from these Tokens.

BC-Key=SHA1 (BC-Home Token, BC-Care-of Token)

Then, using the generated Key and HoT Ring Data on which the authentication code is based, the terminal B generates the following authentication code MAC, and compares it with an authentication code added to the HoT ring message:

BC-MAC=SHA1 (BC-Key, HoT Ring Data)

If the authentication code is correct, the terminal B generates the following HoT Ring Tokens:

BC-HoT Ring Token=SHA1 (C-Home Address, B's secret key, BC-HoT ring nonce)

BA-HoT Ring Token=SHA1 (A-Home Address, B's secret key, BA-HoT ring nonce)

Then, the terminal B adds the following information to the HoT ring message:

C-Home Address, BC-HoT Ring Token, BC-HoT ring nonce

A-Home Address, BA-HoT Ring Token, BA-HoT ring nonce

Further, the terminal B adds Tokens for the next ring message to the terminal A, i.e., it adds the following Tokens:

BA-Home Token2=SHA1 (A-Home Address, B's secret key, BA-home nonce2)

BC-Home Token2=SHA1 (C-Home Address, B's secret key, BC-home nonce2)

Information included in the HoT ring message to be sent from the terminal B to the terminal C in the above processing is the following information:

C-Home Address, AC-HoT Ring Token, AC-HoT ring nonce (information from the terminal A)

C-Home Address, BC-HoT Ring Token, BC-HoT ring nonce (added by the terminal B)

A-Home Address, BA-HoT Ring Token, BA-HoT ring nonce (added by the terminal B)

HoT Ring Data

CA-MAC, CA-home nonce, CA-care-of nonce, A-Care-of Address (information from the terminal A)

AB-MAC, AB-home nonce, AB-care-of nonce, B-Care-of Address (information from the terminal A)

BA-Home Token2, BA-home nonce2, B-Home Address (added by the terminal B)

BC-Home Token2, BC-home nonce2, C-Home Address (added by the terminal B)

Next, HoT ring processing at the terminal C will be described. When receiving the HoT ring message, the terminal C holds the following Ring Tokens addressed to the terminal C:

C-Home Address, AC-HoT Ring Token, AC-HoT ring nonce

C-Home Address, BC-HoT Ring Token, BC-HoT ring nonce

The terminal C checks the authentication code to determine whether to forward the HoT ring message to the terminal A. First, the terminal C generates the following Home Token and Care-of Token using A-Home Address, A-Care-of Address, CA-home nonce and CA-care-of nonce:

CA-Home Token=SHA1 (A-Home Address, C's secret key, CA-home nonce)

CA-Care-of Token=SHA1 (A-Care-of Address, C's secret key, CA-care-of nonce)

Further, the terminal C generates Key from these Tokens.

CA-Key=SHA1 (CA-Home Token, CA-Care-of Token)

Then, using the generated Key and HoT Ring Data on which the authentication code is based, the terminal C generates the following authentication code MAC, and compares it with an authentication code added to the HoT ring message:

CA-MAC=SHA1 (CA-Key, HoT Ring Data)

If the authentication code is correct, the terminal C generates the following HoT Ring Tokens:

CA-HoT Ring Token=SHA1 (A-Home Address, C's secret key, CA-HoT ring nonce)

CB-HoT Ring Token=SHA1 (B-Home Address, C's secret key, CB-HoT ring nonce)

Then, the terminal C adds the following information to the HoT ring message:

A-Home Address, CA-HoT Ring Token, CA-HoT ring nonce

B-Home Address, CB-HoT Ring Token, CB-HoT ring nonce

Further, the terminal C adds Tokens for the next ring message to the terminal A, i.e., it adds the following Tokens:

CA-Home Token2=SHA1 (A-Home Address, C's secret key, CA-home nonce2)

CB-Home Token2=SHA1 (B-Home Address, C's secret key, CB-home nonce2)

Information included in the HoT ring message to be sent from the terminal C to the terminal A in the above processing is the following information:

A-Home Address, BA-HoT Ring Token, BA-HoT ring nonce (information from the terminal B)

A-Home Address, CA-HoT Ring Token, CA-HoT ring nonce (added by the terminal C)

B-Home Address, CB-HoT Ring Token, CB-HoT ring nonce (added by the terminal C)

HoT Ring Data

AB-MAC, AB-home nonce, AB-care-of nonce, B-Care-of Address (information from the terminal A)

BA-Home Token2, BA-home nonce2, B-Home Address (added by the terminal B)

BC-Home Token2, BC-home nonce2, C-Home Address (added by the terminal B)

CA-Home Token2, CA-home nonce2, A-Home Address (added by the terminal C)

CB-Home Token2, CB-home nonce2, B-Home Address (added by the terminal C)

Next, HoT ring processing at the terminal A will be described. When receiving the HoT ring message, the terminal A holds Ring Tokens addressed to the terminal A, i.e., the following information:

A-Home Address, BA-HoT Ring Token, BA-HoT ring nonce

A-Home Address, CA-HoT Ring Token, CA-HoT ring nonce

The terminal A checks the authentication code to determine whether to forward the HoT ring message to the terminal B. First, the terminal A generates the following Home Token and Care-of Token using B-Home Address, B-Care-of Address, AB-home nonce and AB-care-of nonce:

AB-Home Token=SHA1 (B-Home Address, A's secret key, AB-home nonce)

AB-Care-of Token=SHA1 (B-Care-of Address, A's secret key, AB-care-of nonce)

Further, the terminal A generates Key from these Tokens.

AB-Key=SHA1 (AB-Home Token, AB-Care-of Token)

Then, using the generated Key and HoT Ring Data on which the authentication code is based, the terminal A generates the following authentication code MAC, and compares it with an authentication code added to the HoT ring message:

AB-MAC=SHA1 (CA-Key, HoT Ring Data)

Further, the terminal A collects Tokens added for the next ring message. In other words, the following information is collected:

BA-Home Token2, BA-home nonce2, B-Home Address

BC-Home Token2, BC-home nonce2, C-Home Address

CA-Home Token2, CA-home nonce2, A-Home Address

CB-Home Token2, CB-home nonce2, B-Home Address

Note that AB-Home Token2 and AC-Home Token2 are generated by the terminal A upon transmission of the HoT ring message and the CoT ring message. Information included in the HoT ring message to be sent from the terminal A to the terminal B in the above processing is the following information:

B-Home Address, CB-HoT Ring Token, CB-HoT ring nonce (added by the terminal C)

Next, CoT ring processing at the terminal C will be described. The HoT ring processing is almost the same processing as well. When receiving the CoT ring message, the terminal C holds Ring Token addressed to the terminal C. In other words, the terminal C holds the following information:

C-Care-of Address, AC-CoT Ring Token, AC-CoT ring nonce

The terminal C checks the authentication code to determine whether to forward the CoT ring message to the terminal B. First, the terminal C generates the following Home Token and Care-of Token using B-Care-of Address, B-Home Address, CB-home nonce and CB-care-of nonce:

CB-Home Token=SHA1 (B-Home Address, C's secret key, CB-home nonce)

CB-Care-of Token=SHA1 (B-Care-of Address, C's secret key, CB-care-of nonce)

Further, the terminal C generates the following Key from these Tokens:

CB-Key=SHA1 (CB-Home Token, CB-Care-of Token)

Then, using the generated Key and CoT Ring Data on which the authentication code is based, the terminal C generates the following authentication code MAC and compares it with the authentication code added to the CoT ring message:

CB-MAC=SHA1 (CB-Key, CoT Ring Data)

If the authentication code is correct, the terminal C generates the following CoT Ring Tokens:

CB-CoT Ring Token=SHA1 (B-Care-of Address, C's secret key, CB-CoT ring nonce)

CA-CoT Ring Token=SHA1 (A-Care-of Address, C's secret key, CA-CoT ring nonce)

Then, the terminal C adds the following information to the CoT ring message:

B-Care-of Address, CB-CoT Ring Token, CB-CoT ring nonce

A-Care-of Address, CA-CoT Ring Token, CA-CoT ring nonce

Further, the terminal C adds Tokens for the next ring message to the terminal A. In other words, the terminal C adds the following information:

CA-Care-of Token2=SHA1 (A-Care-of Address, C's secret key, CA-care-of nonce2)

CB-Care-of Token2=SHA1 (B-Care-of Address, C's secret key, CB-care-of nonce2)

Information included in the CoT ring message to be sent from the terminal B to the terminal C in the above processing is the following information:

B-Care-of Address, AB-CoT Ring Token, AB-CoT ring nonce (information from the terminal A)

B-Care-of Address, CB-CoT Ring Token, CB-CoT ring nonce (added by the terminal C)

A-Care-of Address, CA-CoT Ring Token, CA-CoT ring nonce (added by the terminal C)

CoT Ring Data

BA-MAC, BA-home nonce, BA-care-of nonce, A-Home Address (information from the terminal A)

AC-MAC, AC-home nonce, AC-care-of nonce, C-Home Address (information from the terminal A)

CA-Care-of Token2, CA-care-of nonce2, A-Care-of Address (added by the terminal C)

CB-Care-of Token2, CB-care-of nonce2, B-Care-of Address (added by the terminal C)

Next, CoT ring processing at the terminal B will be described. When receiving the CoT ring message, the terminal B holds Ring Token addressed to the terminal A. In other words, the terminal B holds the following information:

B-Care-of Address, AB-CoT Ring Token, AB-CoT ring nonce

B-Care-of Address, CB-CoT Ring Token, CB-CoT ring nonce

The terminal B checks the authentication code to determine whether to forward the CoT ring message to the terminal A. First, the terminal B generates the following Home Token and Care-of Token using A-Home Address, A-Care-of Address, BA-home nonce and BA-care-of nonce:

BA-Home Token=SHA1 (A-Home Address, B's secret key, BA-home nonce)

BA-Care-of Token=SHA1 (A-Care-of Address, B's secret key, BA-care-of nonce)

The terminal B generates Key from these Tokens.

BA-Key=SHA1 (BA-Home Token, BA-Care-of Token)

Then, using the generated Key and CoT Ring Data on which the authentication code is based, the terminal B generates the following authentication code MAC and compares it with the authentication code added to the CoT ring message:

BA-MAC=SHA1 (BA-Key, CoT Ring Data)

If the authentication code is correct, the terminal B generates the following CoT Ring Tokens:

BC-CoT Ring Token=SHA1 (C-Care-of Address, B's secret key, BC-CoT ring nonce)

BA-CoT Ring Token=SHA1 (A-Care-of Address, B's secret key, BA-CoT ring nonce)

Then, the terminal B adds the following information to the CoT ring message:

A-Care-of Address, BA-CoT Ring Token, BA-CoT ring nonce

C-Care-of Address, BC-CoT Ring Token, BC-CoT ring nonce

Further, the terminal B adds Tokens for the next ring message to the terminal A. In other words, the terminal B adds the following Tokens:

BA-Care-of Token2=SHA1 (A-Care-of Address, B's secret key, BA-care-of nonce2)

BC-Care-of Token2=SHA1 (C-Care-of Address, B's secret key, BC-care-of nonce2)

Information included in the CoT ring message to be sent from the terminal B to the terminal A in the above processing is the following information:

A-Care-of Address, CA-CoT Ring Token, CA-CoT ring nonce (information from the terminal C)

A-Care-of Address, BA-CoT Ring Token, BA-CoT ring nonce (added by the terminal B)

C-Care-of Address, BC-CoT Ring Token, BC-CoT ring nonce (added by the terminal B)

CoT Ring Data

AC-MAC, AC-home nonce, AC-care-of nonce, C-Home Address (information from the terminal A)

CA-Care-of Token2, CA-care-of nonce2, A-Care-of Address (information from the terminal C)

CB-Care-of Token2, CB-care-of nonce2, B-Care-of Address (information from the terminal C)

BA-Care-of Token2, BA-care-of nonce2, A-Care-of Address (added by the terminal B)

BC-Care-of Token2, BC-care-of nonce2, C-Care-of Address (added by the terminal B)

Next, CoT ring processing at the terminal A will be described. When receiving the CoT ring message, the terminal A holds Ring Tokens addressed to the terminal A. In other words, the terminal A holds the following information:

A-Care-of Address, CA-CoT Ring Token, CA-CoT ring nonce

A-Care-of Address, BA-CoT Ring Token, BA-CoT ring nonce

The terminal A checks the authentication code to determine whether to forward the CoT ring message to the terminal C. First, the terminal A generates the following Home Token and Care-of Token using C-Home Address, C-Care-of Address,

AC-home nonce and AC-care-of nonce:

AC-Home Token=SHA1 (C-Home Address, A's secret key, AC-home nonce)

AC-Care-of Token=SHA1 (C-Care-of Address, A's secret key, AC-care-of nonce)

Further, the terminal A generates Key from these Tokens.

AC-Key=SHA1 (AC-Home Token, AC-Care-of Token)

Then, using the generated Key and CoT Ring Data on which the authentication code is based, the terminal A generates the following authentication code MAC and compares it with the authentication code added to the CoT ring message:

AC-MAC=SHA1 (AC-Key, CoT Ring Data)

Further, the terminal A collects Tokens added for the next ring message. In other words, the following Tokens are collected:

CA-Care-of Token2, CA-care-of nonce2, A-Care-of Address

CB-Care-of Token2, CB-care-of nonce2, B-Care-of Address

BA-Care-of Token2, BA-care-of nonce2, A-Care-of Address

BC-Care-of Token2, BC-care-of nonce2, C-Care-of Address

AB-Care-of Token2 and AC-Care-of Token2 are generated by the terminal A upon transmission of the HoT ring message and CoT ring message. Information included in the CoT ring message to be sent from the terminal A to the terminal C in the above processing is the following information:

C-Care-of Address, BC-CoT Ring Token, BC-CoT ring nonce (information from the terminal B)

Next, the operation of a terminal when receiving both the HoT ring message and the CoT ring message will be described. The terminal B acquires the following information from the HoT ring message:

B-Home Address, AB-HoT Ring Token, AB-HoT ring nonce

B-Home Address, CB-HoT Ring Token, CB-HoT ring nonce

The terminal B also acquires the following information from the CoT ring message:

B-Care-of Address, AB-CoT Ring Token, AB-CoT ring nonce

B-Care-of Address, CB-CoT Ring Token, CB-CoT ring nonce

Using these Tokens, the terminal B generates Keys.

AB-Key=SHA1 (AB-HoT Ring Token, AB-CoT Ring Token)

CB-Key=SHA1 (CB-HoT Ring Token, CB-CoT Ring Token)

Then, using these Keys, the terminal B generates an authentication code, and sends the terminal A a BU message to which AB-HoT ring nonce and AB-CoT ring nonce are added together with the generated authentication code and the like. Further, the terminal B sends the terminal C a BU message to which CB-HoT ring nonce and CB-CoT ring nonce are added together with the generated authentication code and the like.

On the other hand, the terminal C acquires the following information from the HoT ring message:

C-Home Address, AC-HoT Ring Token, AC-HoT ring nonce

C-Home Address, BC-HoT Ring Token, BC-HoT ring nonce

The terminal C also acquires the following information from the CoT ring message:

C-Care-of Address, AC-CoT Ring Token, AC-CoT ring nonce

C-Care-of Address, BC-CoT Ring Token, BC-CoT ring nonce

Using these Tokens, the terminal C generates Keys.

AC-Key=SHA1 (AC-HoT Ring Token, AC-CoT Ring Token)

BC-Key=SHA1 (BC-HoT Ring Token, BC-CoT Ring Token)

Then, using these Keys, the terminal C generates an authentication code, and sends the terminal A a BU message to which AC-HoT ring nonce and AC-CoT ring nonce are added together with the generated authentication code and the like. Further, the terminal C sends the terminal B a BU message to which BC-HoT ring nonce and BC-CoT ring nonce are added together with the generated authentication code and the like.

On the other hand, the terminal A acquires the following information from the HoT ring message:

A-Home Address, BA-HoT Ring Token, BA-HoT ring nonce

A-Home Address, CA-HoT Ring Token, CA-HoT ring nonce

The terminal A also acquires the following information from the CoT ring message:

A-Care-of Address, CA-CoT Ring Token, CA-CoT ring nonce

A-Care-of Address, BA-CoT Ring Token, BA-CoT ring nonce

Using these Tokens, the terminal A generates Keys.

BA-Key=SHA1 (BA-HoT Ring Token, BA-CoT Ring Token)

CA-Key=SHA1 (CA-HoT Ring Token, CA-CoT Ring Token)

Then, using these Keys, the terminal A generates an authentication code, and sends the terminal B a BU message to which BA-HoT ring nonce and BA-CoT ring nonce are added together with the generated authentication code and the like. Further, the terminal A sends the terminal C a BU message to which CA-HoT ring nonce and CA-CoT ring nonce are added together with the generated authentication code and the like.

The same processing can be performed even in a case where the number of the terminals is four or more. For example, when the number of the terminals is four, the terminal A instructs terminal D to perform binding update to the terminal B and the terminal C. The terminal A also instructs the terminal B and the terminal C to perform binding update to the terminal D. Then, the terminal A collects Token. The terminal A generates a ring list, generates Token to be sent to each terminal, generates an authentication code, and sends a HoT ring message and a CoT ring message to which these pieces of information are added.

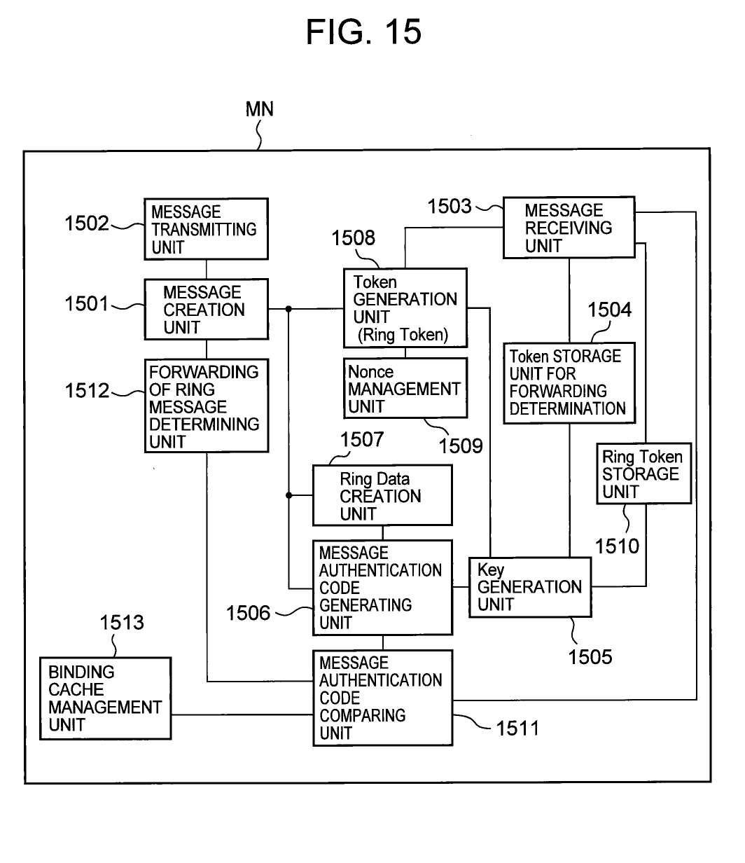

Referring next to FIG. 15, a mobile terminal on the side of initiating the above-mentioned ring binding update will be described. Here, the terminal A is taken as an example to describe a case where the terminal A performs ring binding update to the terminal B and the terminal C. First, the terminal A creates, in a message creation unit 1501, a message to request the terminal B and the terminal C to perform BU to each other, and sends the message from a message transmitting unit 1502. A response message to the message sent is received at a message receiving unit 1503, and Tokens included in the response message are stored in a Token storage unit for forwarding determination 1504.

Upon generating a message authentication code for forwarding determination using the collected Tokens, the terminal A first acquires Tokens from the Token storage unit for forwarding determination 1504, and generates key data in a Key generation unit 1505. Then, a message authentication code generating unit 1506 acquires Ring Data from a Ring Data creation unit 1507, and generates a message authentication code using the key data generated by the Key generation unit 1505.

Further, Ring Tokens are generated in a Token generation unit 1508. Nonces used for Token generation are managed and stored in a Nonce management unit 1509. The message creation unit 1501 creates a HoT ring message/CoT ring message to which the message authentication code for forwarding determination, Ring Data and Ring Token are added. The HoT ring message/CoT ring message is sent from the message transmitting unit 1502.

After that, when receiving, at the message receiving unit 1503, the ring message passed around, Ring Tokens addressed to its own terminal are stored in the Ring Token storage unit 1510. If any forwarding destination remains, Tokens are generated in the Token generation unit 1508, key data is generated in the Key generation unit 1505, and a message authentication code is generated in the message authentication code generating unit 1506 using the Ring Data added to the message. In a message authentication code comparing unit 1511, the generated message authentication code is compared with a message authentication code added to the message, and in a forwarding of ring message determining unit 1512, it is determined whether to perform forwarding. Further, Tokens for the next ring message included in the ring message are stored in the Token storage unit for forwarding determination 1504.

When both Tokens, Home Token and Care-of Token, are gathered in the Ring Token storage unit 1510, key data is generated in the Key generation unit 1505, and a message authentication code is generated based on message data in the message authentication code generating unit 1506. The generated message authentication code is added to the BU message in the message creation unit 1501, and sent from the message transmitting unit 1502.

Since the following is the same as normal MIP binding update processing, a brief description will be given. When receiving a HoTI/CoTI message at the message receiving unit 1503, Tokens are generated in the Token generation unit 1508, a response message is created in the message creation unit 1501, and the created message is sent from the message transmitting unit 1502. Nonces used upon Token generation are stored and managed in the Nonce management unit 1509.

Then, when receiving a BU message, Home Token and Care-of Token are generated in the Token generation unit 1508 using addresses and Nonce-IDs included. Using the generated Tokens, key data is generated in the Key generation unit 1505, and using the key data and the message data, a message authentication code is generated in the message authentication code generating unit 1506. In the message authentication code comparing unit 1511, the generated message authentication code is compared with a message authentication code added to the BU message, and if they match, a binding cache is registered in a binding cache management unit 1513.

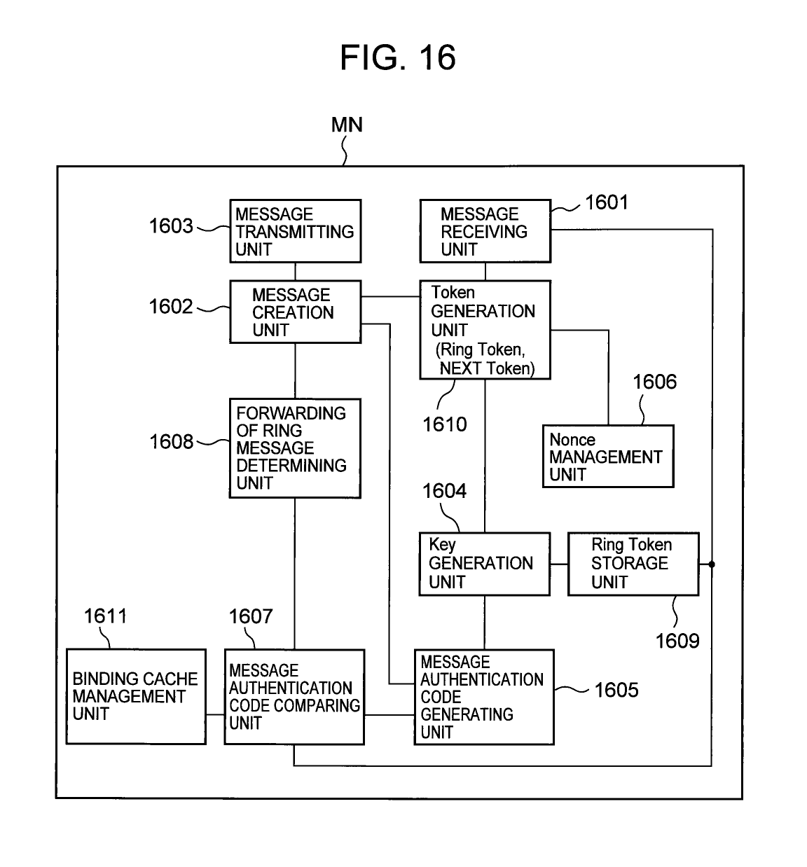

Referring next to FIG. 16, a mobile terminal on the side of participating in ring binding update will be described. Here, the terminal B is taken as an example to describe a case where the terminal A performs ring binding update to the terminal B and the terminal C. In response to a request from the terminal A, the terminal B sends HoTI/CoTI to the terminal C, and receives HoT/CoT. Then, Tokens included in the HoT/CoT are sent to HoA and CoA of the terminal A, respectively. In this processing, when receiving, at a message receiving unit 1601, the request from the terminal A, the terminal B creates HoTI/CoTI in a message creation unit 1602, and sends it from a message transmitting unit 1603.

When receiving HoT/CoT, the terminal B generates key data for the terminal C in a Key generation unit 1604, generates a message authentication code in a message authentication code generating unit 1605, adds the generated message authentication code to a BU message, and sends the BU message. On the other hand, for the terminal A, a message with which Tokens addressed to HoA and CoA are sent is created in the message creation unit 1602, and sent from the message transmitting unit 1603.

When receiving a HoT ring message or CoT ring message from the terminal A, the terminal B first checks the message authentication code for forwarding determination. To this end, Tokens are generated using Nonces acquired from the Nonce management unit 1606 using the addresses of the forwarding destination terminal and Nonce-IDs included in the message. Using the generated Home Token and Care-of Token, key data is generated in the Key generation unit 1604. Then, using the generated key data and Ring Data added to the message, a message authentication code is generated in the message authentication code generating unit 1605, and in the message authentication code comparing unit 1607, the generated message authentication code is compared with a message authentication code added to the ring message. In response to the result indicating that the message authentication codes match, the forwarding of ring message determining unit 1608 decides to perform forwarding.

Ring Tokens included in the ring message and addressed to its own terminal are stored in the Ring Token storage unit 1609. The message creation unit 1602 adds, to the ring message to be forwarded, Ring Tokens generated in the Token generation unit 1610 to be addressed to the forwarding destination terminal, and Tokens used in the next ring message. Then, the ring message is sent from the message transmitting unit 1603. After the terminal B receives the ring message, when both HoT Ring Token and CoT Ring Token are gathered, key data is generated in the Key generation unit 1604 to create a BU message, a message authentication code is generated in the message authentication code generating unit 1605, the generated message authentication code is added to the BU message in the message creation unit 1602, and the BU message is sent from the message transmitting unit 1603.

Since the following is the same as normal MIP binding update processing, a brief description will be given. When receiving HoTI/CoTI at the message receiving unit 1601, Tokens are generated in the Token generation unit 1610, a response message is created in the message creation unit 1602, and the created message is sent from the message transmitting unit 1603. Nonces used upon Token generation are stored and managed in the Nonce management unit 1606.

Then, when the terminal B receives the BU message, Home Token and Care-of Token are generated in the Token generation unit 1610 using addresses and Nonce-IDs included. Using the generated Tokens, key data is generated in the Key generation unit 1604, and using the key data and message data, a message authentication code is generated in the message authentication code generating unit 1605. In the message authentication code comparing unit 1607, the generated message authentication code is compared with a message authentication code added to the BU message, and if they match, a binding cache is registered in a binding cache management unit 1611.

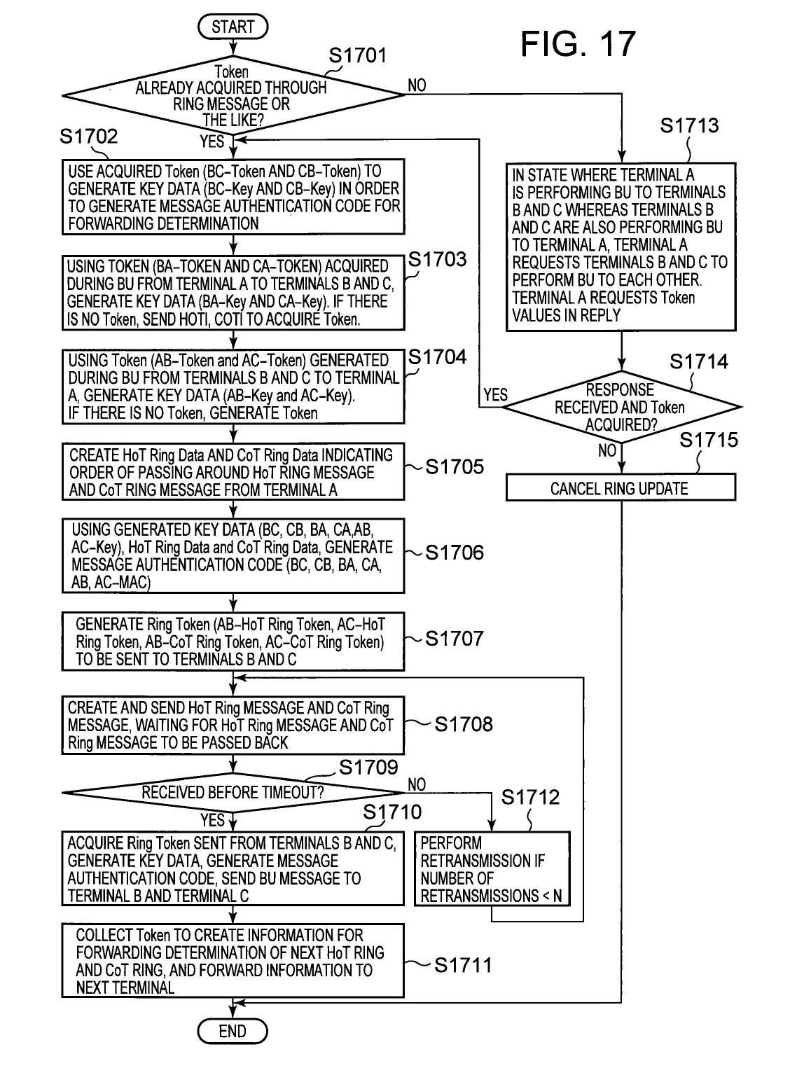

Referring next to FIG. 17, a processing flow in a mobile terminal on the side of initiating ring binding update will be described. As shown in FIG. 17, the terminal A checks whether it has already acquired Tokens through the ring message or the like (step S1701). If already acquired, the terminal A uses the acquired Tokens (BC-Token and CB-Token) to generate key data (BC-Key and CB-Key) in order to generate a message authentication code for forwarding determination (step S1702).

Then, using Tokens (BA-Token and CA-Token) acquired during BU from the terminal A to the terminals B and C. The terminal A generates key data (BA-Key and CA-Key) (step S1703). If there is no Token (BA-Token or CA-Token), HoTI/CoTI is sent to acquire the Token. Further, using Tokens (AB-Token and AC-Token) generated during BU from the terminals B and C to the terminal, the terminal A generates key data (AB-Key and AC-Key) (step S1704). If there is no Token (AB-Token or AC-Token), the Token is generated.

The terminal A creates HoT Ring Data and CoT Ring Data indicating the order of passing around the HoT ring message and CoT ring message from the terminal A (step S1705). Using the generated key data (BC-Key, CB-Key, BA-Key, CA-Key, AB-Key, AC-Key), HoT Ring Data and CoT Ring Data, the terminal A generates a message authentication code (BC-MAC, CB-MAC, BA-MAC, CA-MAC, AB-MAC, AC-MAC) (step S1706). The terminal A also generates Ring Tokens (AB-HoT Ring Token, AC-HoT Ring Token, AB-CoT Ring Token, AC-CoT Ring Token) to be sent to the terminal B and the terminal C (step S1707).

The terminal A creates and sends HoT Ring message and CoT Ring message, waiting for the HoT Ring message and CoT Ring message to be passed back (step S1708). The terminal A determines whether the messages have been received before a predetermined timeout (step S1709). If the message has been received, the terminal A acquires Ring Tokens sent from the terminals B and C, generates key data, generates a message authentication code, and sends a BU message to the terminals B and C (step S1710). The terminal A collects Tokens to create information for forwarding determination on the next HoT ring message and CoT ring message, and forwards them to the next terminal (step S1711). In step S1709, if no message has been received, the terminal A performs retransmission on condition that the number of retransmissions is smaller than a predetermined value N (step S1712).

Further, in step S1701, if no Token is acquired, the terminal A requests the terminal B and the terminal C to perform BU to each other in a state that the terminal A is performing BU to the terminals B and C whereas the terminals B and C are performing BU to the terminal A, requesting Token values in reply (step S1713). The terminal A determines whether a response is received and Tokens are acquired (step S1714). If a response is received and Tokens are acquired, processing proceeds to step S1702. If it is determined that no Token is acquired, ring update is cancelled (step S1715).

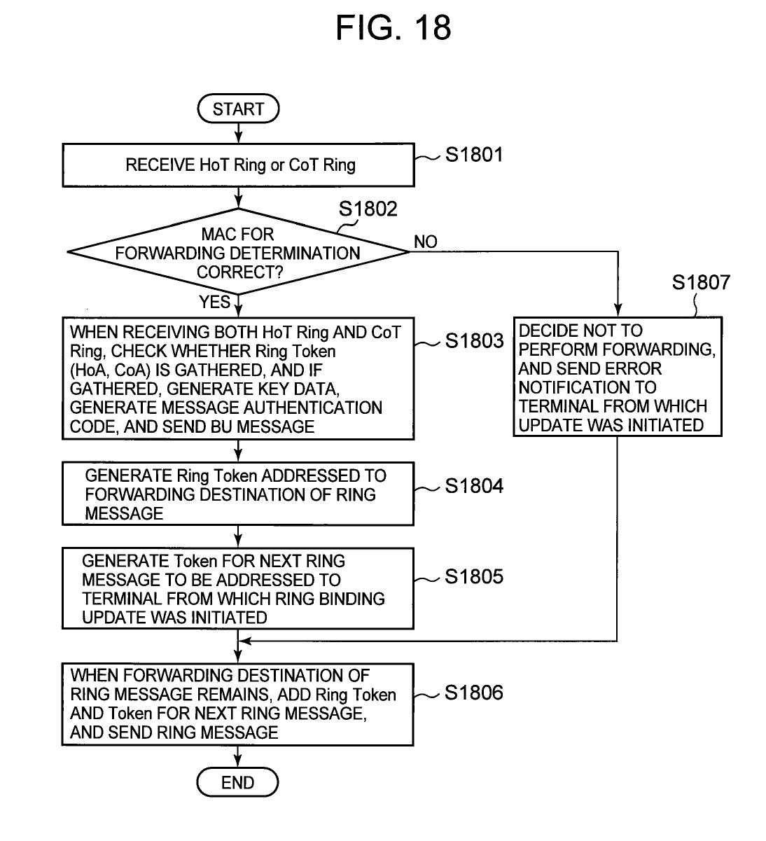

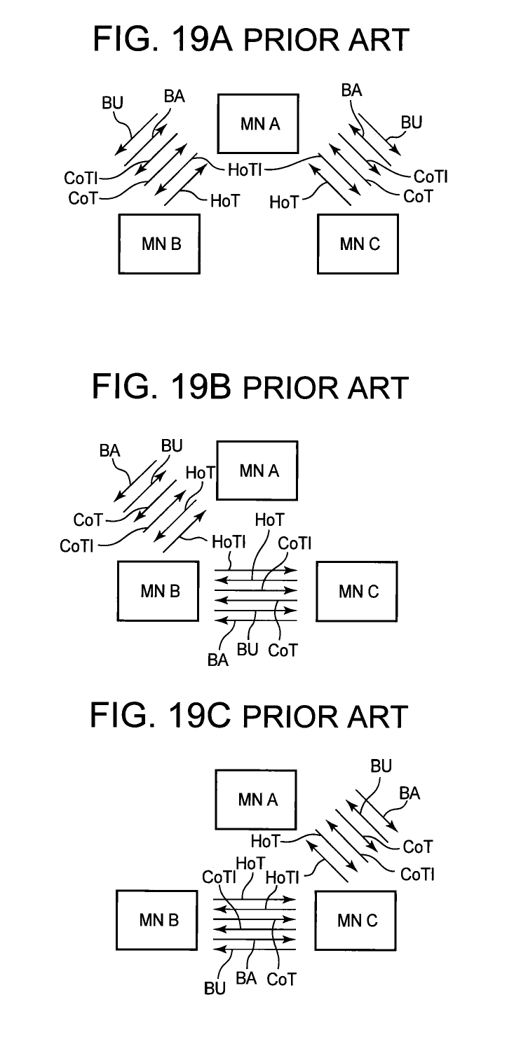

Referring next to FIG. 18, a processing flow in a mobile terminal on the side of participating in ring binding update will be described. As shown in FIG. 18, the terminal B receives a HoT ring message or CoT ring message, for example (step S1801). The terminal B determines whether MAC for forwarding determination is correct (step S1802). When MAC is correct and when the terminal B receives both the HoT ring message and the CoT ring message, the terminal B checks whether Ring Tokens (HoA, CoA) are gathered. If gathered, the terminal B generates key data, generates a message authentication code, and sends a BU message (step S1803).

The terminal B generates Ring Tokens addressed to the forwarding destination of the ring message (step S1804). Then, the terminal B generates Tokens for the next ring message to be addressed to the terminal that initiated the ring binding update (step S1805). When any forwarding destination of the ring message remains, the terminal B adds Ring Tokens and Tokens for the next ring message to the ring message, and forwards the ring message (step S1806). In step S1802, if MAC for forwarding determination is not correct, the terminal B decides not to perform forwarding, and sends an error notification to the terminal from which the ring binding update was initiated (step S1807).

In the above description, the terminal A decides a terminal to which a ring message is to be sent, but a server in a network may decide the terminal. For example, the server may decide on members among which a ring message is passed around, and instructs a certain terminal to send the ring message. Further, an inter-group communication application running on a terminal may decide on terminal members among which a ring message is passed around, and instructs a terminal to initiate ring binding update.

Each of the functional blocks used in describing the aforementioned embodiments of the present invention is implemented as an LSI (Large Scale Integration) typified by an integrated circuit. These may be made up of one chip individually, or they may be made up of one chip to include some or all of them. Here, although the LSI is assumed, it may be called an IC (Integrated Circuit), a system LSI, a super LSI, or an ultra LSI depending on the degree of integration. Further, the technique for creation of an integrated circuit is not limited to LSI, and it may be implemented by a private circuit or a general-purpose processor. An FPGA (Field Programmable Gate Array) capable of programming after LSI manufacturing or a reconfigurable processor capable of reconfiguring connections or settings of circuit cells within the LSI may also be employed. In addition, if integrated circuit technology capable of replacing LSI emerges with the development of semiconductor technology or another technology derived therefrom, the technology may of course be used to integrate the functional blocks. For example, applications of biotechnology may be possible.

### INDUSTRIAL APPLICABILITY

A binding updating method and a mobile terminal used by the method according to the present invention can reduces the number of messages required during binding update performed among terminals. The reduction in the number of messages can result in reduction in power consumption of each terminal, and further reduction in processing time required for binding update among terminals. Therefore, the present invention is effective in a binding updating method for updating binding between communication terminals which a path is optimized by binding update, and a mobile terminal used by the method.

1. A binding updating method for updating binding information for enabling route optimization between two mobile terminals of multiple mobile terminals in a communication network using the multiple mobile terminals, the method comprising the steps of:
causing a predetermined mobile terminal of the multiple mobile terminals to send a mobile terminal as a next destination a first message and a second message including predetermined information for each of other mobile terminals based on a predetermined order of message transmission;
causing a mobile terminal that has received the first and second messages to acquire predetermined information included in the first and second messages and addressed to its own terminal, add predetermined information for each of the mobile terminals other than its own terminal to the first and second messages, and send the first and second messages to a mobile terminal as the next destination based on the predetermined order of message transmission;
causing a mobile terminal that has acquired all pieces of predetermined information addressed to its own terminal to generate authentication information for each of other mobile terminals based on the acquired predetermined information, and create and send a third message including the generated authentication information for each of the other mobile terminals; and
causing a mobile terminal that has received the third message to update the binding information when the authentication information included in the third message is validated.

2. The binding updating method according to claim 1, wherein the predetermined order of message transmission is such that the order of transmission of the first message is different from the order of transmission of the second message.

3. The binding updating method according to claim 2, wherein the predetermined mobile terminal generates, for each of the mobile terminals, authentication information for the forwarding determination of message based on predetermined information on the mobile terminals other than the predetermined mobile terminal, adds the generated authentication information for the forwarding determination to the first and second messages, and sends the first and second messages.

4. The binding updating method according to claim 3, wherein the mobile terminal that has received the first and second messages adds, to the first and second messages, predetermined information used upon transmission of the first and second messages for next binding update.

5. A mobile terminal used by a binding updating method for updating binding information for enabling route optimization between two mobile terminals of multiple mobile terminals in a communication network using the multiple mobile terminals, the mobile terminal comprising:
message creation means for creating a first message and a second message including predetermined information for each of other mobile terminals;
transmitting means for sending the created first and second messages to a mobile terminal as a next destination based on a predetermined order of message transmission;
receiving means for receiving the first and second messages passed around among the multiple mobile terminals;
acquisition means for acquiring predetermined information added to the received first and second messages and addressed to its own terminal;
authentication information generating means for generating authentication information for each of the mobile terminals other than its own terminal based on the predetermined information acquired;
determination means for determining whether the received authentication information is valid when the messages including the authentication information sent from mobile terminals other than its own terminal have been received through the receiving means; and
updating means for updating the binding information when the authentication information is determined to be valid,
wherein the messages including the authentication information generated by the message generation means are sent to the mobile terminals other than its own terminal through the transmitting means.

6. The mobile terminal according to claim 5, wherein the predetermined order of message transmission is such that the order of transmission of the first message is different from the order of transmission of the second message.

7. The mobile terminal according to claim 6, wherein
the authentication information generating means generates, for each of the mobile terminals, authentication information for the forwarding determination of message based on predetermined information on the mobile terminals other than its own terminal, and adds the generated authentication information for the forwarding determination to the first and second messages, and
the transmitting means sends the first and second messages to which the authentication information for the forwarding determination is added.

8. A mobile terminal used by a binding updating method for updating binding information for enabling route optimization between two mobile terminals of multiple mobile terminals in a communication network using the multiple mobile terminals, the mobile terminal comprising:
receiving means for receiving a first message and a second message as messages sent from a predetermined mobile terminal of the multiple mobile terminals and including predetermined information for each of mobile terminals other than the predetermined mobile terminal;
acquisition means for acquiring predetermined information included in the received first and second messages and addressed to its own terminal;
addition means for adding, to the first and second messages, predetermined information for each of mobile terminals other than its own terminal;
transmitting means for sending other mobile terminals the first and second messages to which the predetermined information is added;
authentication information generating means for generating authentication information for each of other mobile terminals based on the acquired predetermined information when all pieces of predetermined information addressed to its own terminal are acquired;
message creation means for creating a message including the generated authentication information for each of the other mobile terminals;
determination means for determining whether the received authentication information is valid when the message including the authentication information sent from mobile terminals other than its own terminal have been received through the receiving means; and
updating means for updating the binding information when the authentication information is determined to be valid,
wherein the message created by the message creation means is sent to each of the other mobile terminals.

9. The mobile terminal according to claim 8, wherein when receiving the first and second messages through the receiving means, the addition means adds, to the first and second messages, predetermined information used upon transmission of the first and second messages for next binding update.
